(19) United States
(12) Patent Application Publication
(10) Pub. No.: US 2011/0141340 A1
(43) Pub. Date: Jun. 16, 2011

(54) INTERCHANGEABLE LENS AND CAMERA SYSTEM USING THE SAME

(76) Inventors: Naoto Yumiki, Osaka (JP); Hironori Honsho, Hyogo (JP); Hideaki Mukae, Hyogo (JP); Yusuke Adachi, Osaka (JP); Kenichi Honjo, Osaka (JP)

(21) Appl. No.: 12/599,222

(22) PCT Filed: May 2, 2008
(86) PCT No.: PCT/JP2008/001141

§ 371 Date: Nov. 6, 2009

(30) Foreign Application Priority Data
May 7, 2007 (JP) 2007-122591

(51) Int. Cl. H04N 5/232; G02B 7/04

(52) U.S. Cl. 348/345; 359/699; 348/E05.045

(57) ABSTRACT

A camera system for linearly driving a focus lens group by an ultrasonic actuator in a single-lens reflex digital camera to perform focusing operation by a contrast detection method is provided.

A focus lens group and an ultrasonic actuator are configured as a focus unit, and the focus lens group is supported by a guide pole, and is linearly driven by the ultrasonic actuator. The focus lens unit is mechanically connected to a zoom cam ring, so that the focus lens unit is movable to a predetermined position in an optical axis direction by zoom operation. In auto-focusing operation, contrast detection is performed by an imaging device to obtain a contrast peak, and the focus lens group is moved to a predetermined position by an electronic control method, whereby focus adjustment is performed.

### TECHNICAL FIELD

The present disclosure relates to imaging apparatuses, and more particularly to interchangeable lens type digital camera systems.

### BACKGROUND ART

In recent years, single-lens reflex digital cameras, which are capable of converting an optical image of an object to an electric image signal and outputting the electric image signal, have rapidly become popular. An interchangeable lens type capable of attaching and detaching a lens is common for the single-lens reflex digital cameras.

Patent Document 1 discloses a configuration for common single-lens reflex interchangeable lenses. A focus lens group of an optical system used in this interchangeable lens is configured to be driven in a direction parallel to an optical axis, while being controlled by cam grooves that are specific to interchangeable lenses.

Patent Document 2 discloses a system for driving a lens group in, a lens barrel by using an ultrasonic actuator that is capable of achieving high torque, high-speed driving, and reduced noise, as a new actuator configuration.

### CITATION LIST

### Patent Document

PATENT DOCUMENT 1: Japanese Published Patent Application No. 2006-113289

PATENT DOCUMENT 2: Japanese Published Patent Application No. 2006-330077

### SUMMARY OF THE INVENTION

### Technical Problem

Incidentally, many single lens reflex cameras use a phase difference detection method as a focusing method. A new focus system capable of making accurate in-focus determination can be implemented by using a contrast detection method instead of the phase difference detection method. In this contrast method, an object image is brought into focus by: for example, obtaining an auto-focusing evaluation value, which is calculated based on image data produced by an imaging device, while moving a focus lens group; moving the focus lens group until the evaluation value once exceeds a peak; and then returning the focus lens group to the position where the evaluation value reached the peak. Thus, in such a contrast auto-focusing operation, the focus lens group needs to be reciprocated in a direction parallel to an optical axis.

Similarly, when it is necessary to bring a moving object into focus, such as when capturing a moving picture, the focus lens group needs to be reciprocated according to the movement of the object.

However, in the configuration of driving the focus lens group by a cam mechanism, it is difficult to quickly reverse the moving direction of the focus lens group, due to looseness that is specific to cam mechanisms, or the like.

The present invention was developed in view of the above problem, and it is an object of the present invention to smoothly operate a focus lens group at a high speed.

### Solution to the Problem

An interchangeable lens of the present invention includes: an imaging optical system including a focus lens group for chaging a focus state of an object imagine, and a zoom lens group for changing magnification of the object image; a zoom operation section that is operated by a user; a cam mechanism for mechanically transmitting operation of the zoom operation section to the zoom lens group to move the zoom lens group in a direction parallel to an optical axis; and a focus unit for advancing and withdrawing the focus lens group in an optical axis direction, where the focus unit itself is also moved in the direction parallel to the optical axis by the cam mechanism, wherein the focus unit supports the focus lens group so that the focus lens group is movable in the optical axis direction, and has a linear actuator for moving the focus lens group in the direction parallel to the optical axis.

Moreover, a camera system of the present invention is a camera system including a camera main body, and an interchangeable lens that is detachable from the camera main body, for capturing an object. The camera system includes: an imaging device provided in the camera main body, for imaging the object; an imaging optical system provided in the interchangeable lens, and including a focus lens group for changing a focus state of an object image onto the imaging device, and a zoom lens group for changing magnification of the object image; a zoom operation section provided in the interchangeable lens so as to be operated by a user; a cam mechanism provided in the interchangeable lens, for mechanically transmitting operation of the zoom operation section to the zoom lens group to move the zoom lens group in a direction parallel to an optical axis; a focus unit provided in the interchangeable lens, for advancing and withdrawing the focus lens group in an optical axis direction, where the focus unit itself is also moved in the direction parallel to the optical axis by the cam mechanism; and a control section provided in the camera main body, for controlling the focus unit, wherein the focus unit supports the focus lens group so that the focus lens group is slidable in the direction parallel to the optical axis, and has a linear actuator for moving the focus lens group in the direction parallel to the optical axis, and the control section controls the linear actuator to perform auto-focusing operation by a contrast detection method, based on an output of the imaging device.

### Advantages of the Invention

According to the present invention, by linearly driving a focus lens group in a direction parallel to an optical axis by a cam mechanism and a linear actuator, the focus lens group can be smoothly operated at a high speed, whereby a response property of the focus lens group can be improved.

### BRIEF DESCRIPTION OF THE DRAWINGS

FIG. 1 is a block diagram showing the configuration of a camera system according to an embodiment.

FIG. 2 is a block diagram showing the configuration of a camera main body according to the embodiment.

FIG. 3 is a perspective view showing the appearance of a camera system according to the embodiment.

FIG. 4 is a diagram showing a schematic configuration of the camera main body according to the embodiment.

FIG. 5 is a cross-sectional view showing a wide angle end of an interchangeable lens according to the embodiment.

FIG. 6 is a cross-sectional view showing a telescopic end of the interchangeable lens according to the embodiment.

FIG. 7 is an exploded perspective view showing the configuration of a focus lens unit according to the embodiment.

FIG. 8 is an assembled perspective view showing the configuration of the focus lens unit according to the embodiment.

FIG. 9 is a perspective view showing a main part of an ultrasonic actuator unit according to the embodiment.

FIG. 10 is a schematic diagram of the ultrasonic actuator unit according to the embodiment.

FIG. 11 is an assembled perspective view showing a second form of the focus lens unit according to the embodiment.

FIG. 12 is an assembled perspective view showing a third form of the focus lens unit according to the embodiment.

FIG. 13 is a displacement diagram showing a second order mode of bending vibration of a piezoelectric element of the ultrasonic actuator unit according to the embodiment.

FIG. 14 is a displacement diagram showing stretching vibration of the piezoelectric element of the ultrasonic actuator unit according to the embodiment.

FIG. 15(a) through FIG. 15(d) are conceptual diagrams showing operation of the piezoelectric element of the ultrasonic actuator unit according to the embodiment.

### DESCRIPTION OF REFERENCE CHARACTERS

1 Camera System
2 Interchangeable lens
3 Camera Main Body
3a Housing
4 Body Mount
10 Body Microcomputer
11 Image Sensor
12 Image Sensor Drive Control Section
20 Display Section
21 Image Display Control Section
25 Power Switch
26 Shooting/Playback Mode Switching Section
27 Cross Operation Key
28 MENU Setting Operation Section
29 SET Operation Section
30 Shutter Operation Section
31 Shutter Control Section
33 Shutter Unit
34 Shooting Mode Switch Button
40 Lens Microcomputer
41 Focus Lens Drive Control Section
50 Fixed Frame
52 First-Second Group Rotary Frame
53 First-Second Group Linearly Moving Frame
54 First Group Holder
55 Third-Fourth Group Rotary Frame
57 First Group Lens Holding Frame
58 Second Group Lens Holding Frame
59 Third Group Lens Holding Frame
60 Fourth Group Lens Holding Frame
61 Second Group Holder
62 Filter Mount
63 Zoom Ring Unit
64 Zoom Ring
66 Focus Ring Unit
67 Focus Ring
71 Lens Mount
74a, 74b, 74c Guide Pole
75 Second Group Fixed Frame
76 Magnetic Scale
77 Magnetic Sensor
78 Focus Lens Unit
79 Ultrasonic Actuator Unit
80a Movable Portion
80b Fixed Portion
81 Piezoelectric Element
82 Driver Element
83 Sliding Plate
84 Inner Case
88 Feeding Electrode
90 Outer Case
L Imaging Optical System
L1 First Group Lens
L2 Second Group Lens (Focus Lens Group)
L3 Third Group Lens
L4 Fourth Group Lens

### DESCRIPTION OF EMBODIMENTS

Embodiments of the present invention will be described in detail below with reference to the accompanying drawings.

[1: Configuration of Camera System]

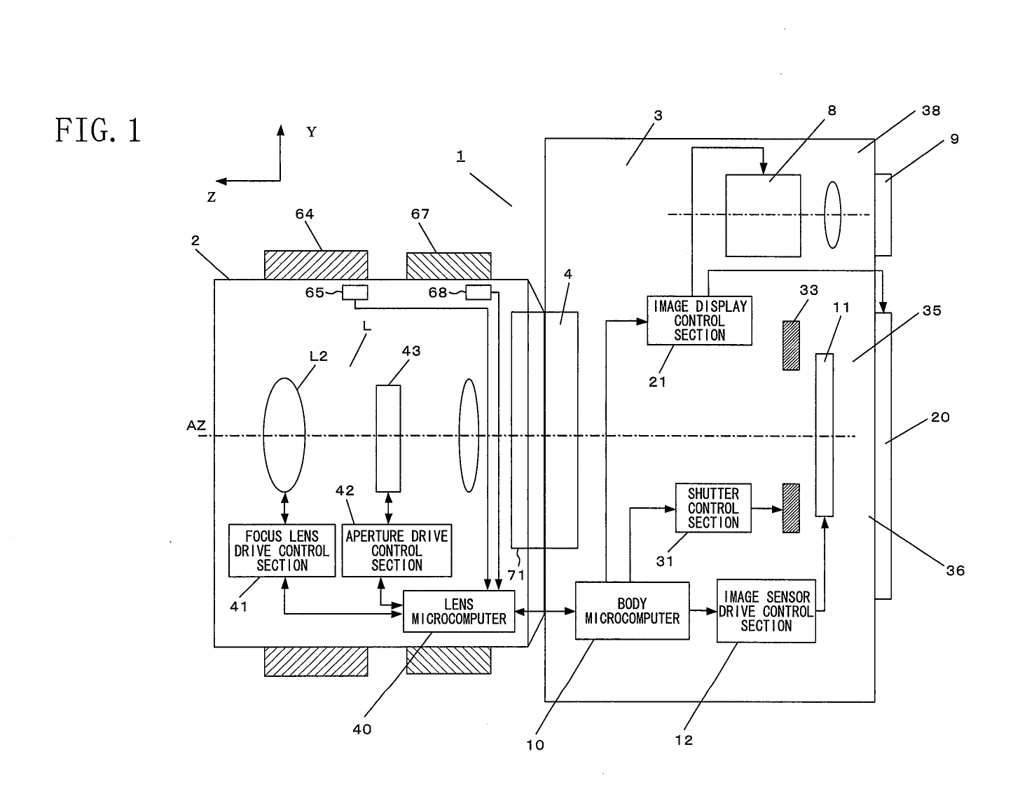

As shown in FIG. 1, a camera system 1 is a system of an interchangeable lens type single-lens reflex camera, and includes a camera main body 3 having primary functions of the camera system 1, and an interchangeable lens 2 that is detachably attached to the camera main body 3. The interchangeable lens 2 is attached to a body mount 4, which is provided on the front face of the camera main body 3, via a lens mount 71, provided at the rearmost part of the interchangeable lens 2. Note that, in the following description, “front” means the object side, and “rear” means the operator side. Moreover, the “operator” means the user of the camera system 1.

(1.1: Interchangeable Lens)

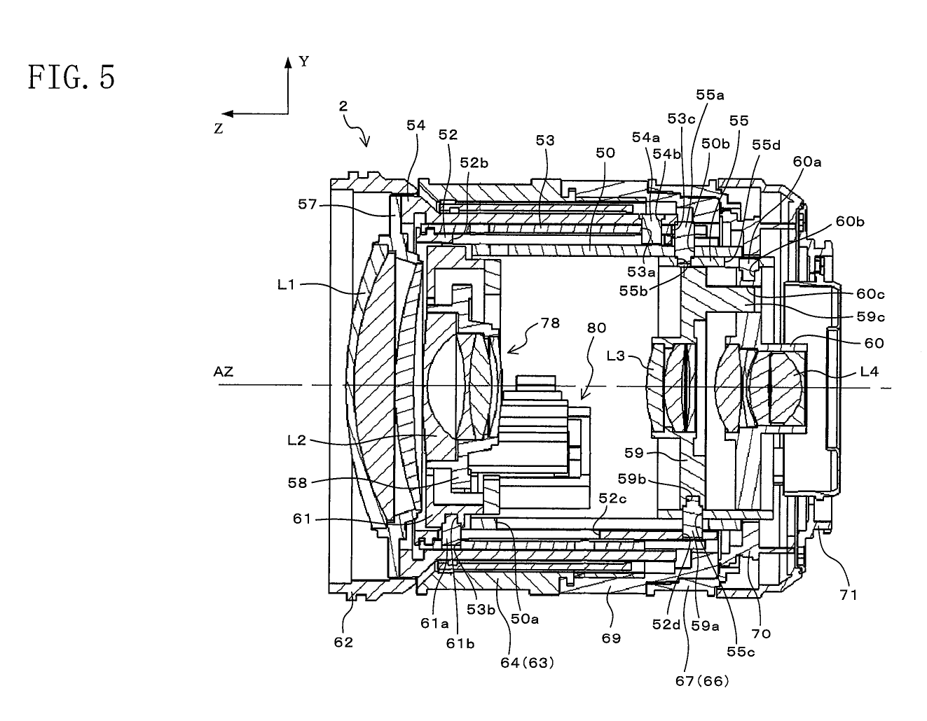

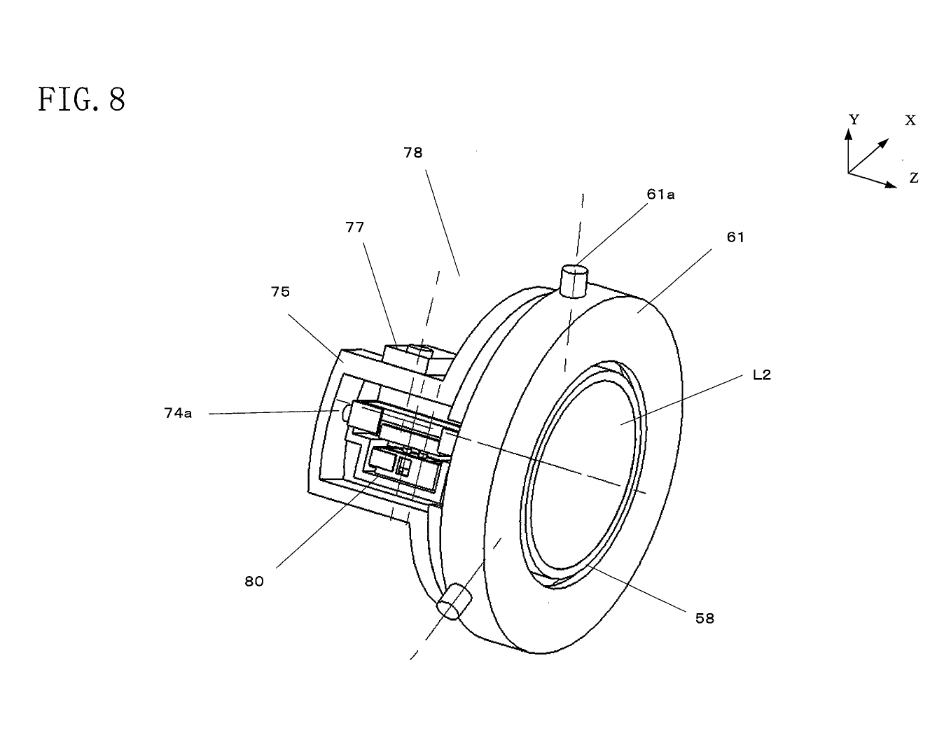

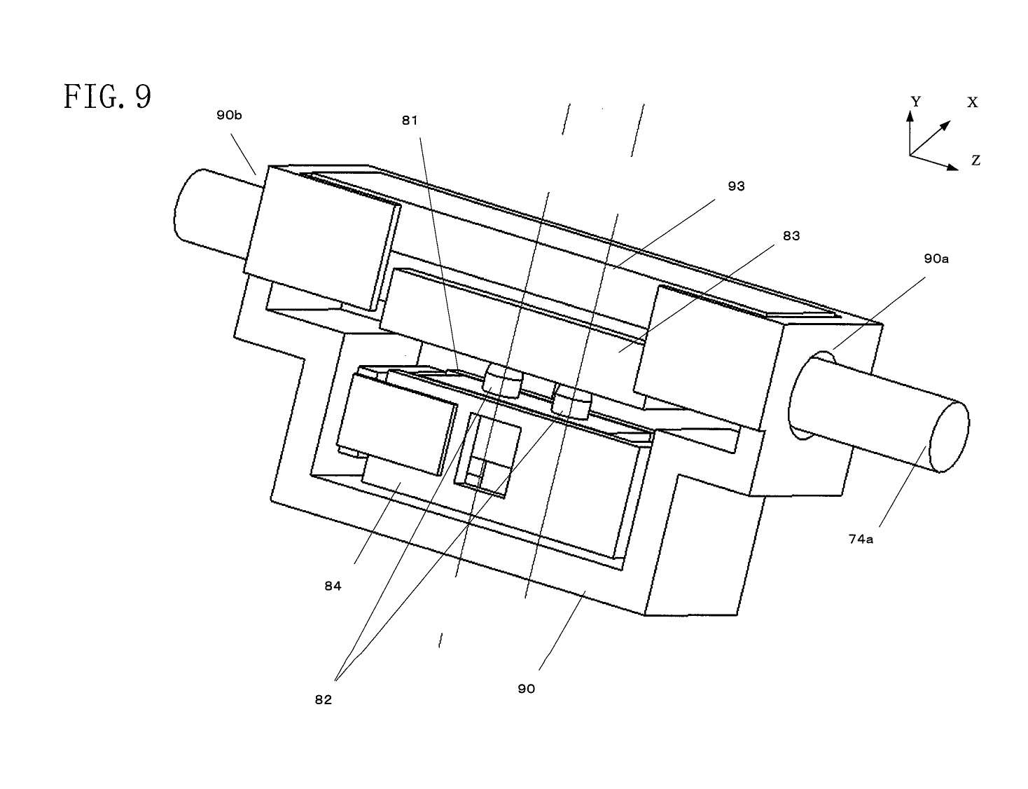

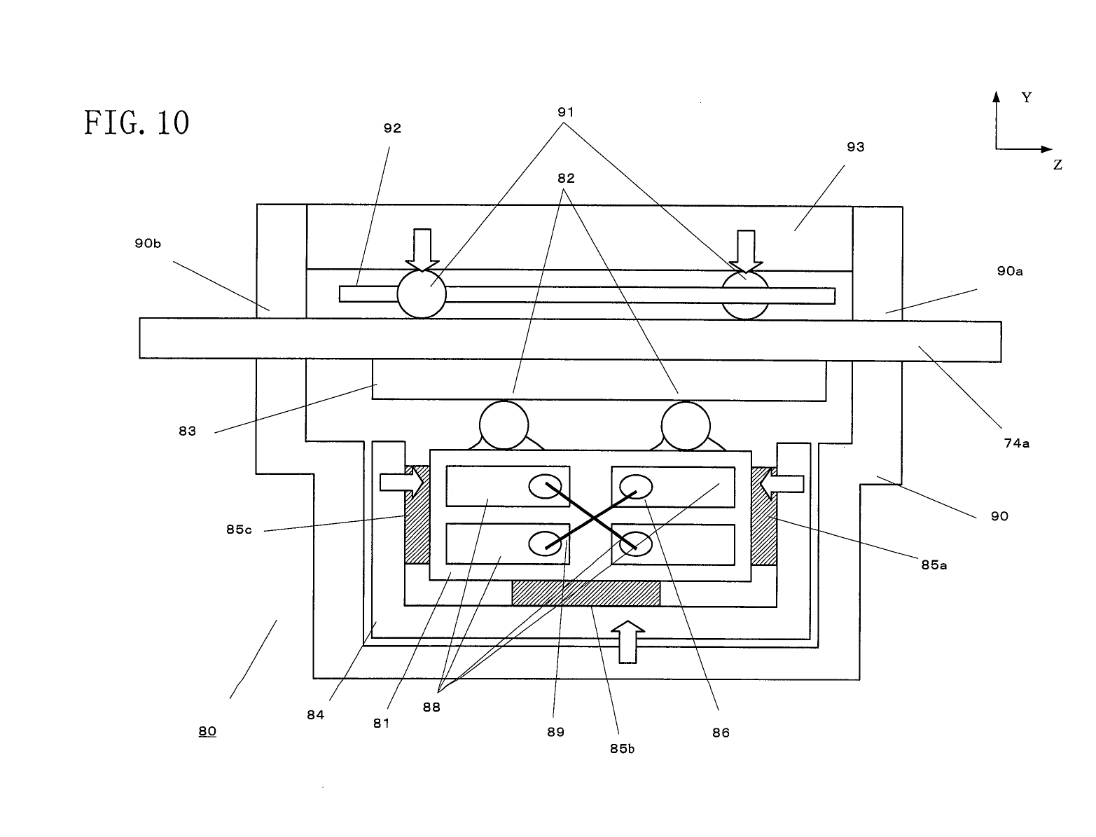

First, a schematic structure of the interchangeable lens 2 will be described below with reference to FIGS. 5 through 10. As shown in the figures, an XYZ three-dimensional rectangular coordinate system is set, with an optical axis AZ of the interchangeable lens 2 being a Z axis (the object side is positive, and the image surface side is negative).

The interchangeable lens 2 has: an imaging optical system L for forming an object image on an image sensor (an imaging device) 11, described below, in the camera system 1; a focus lens drive control section 41 for performing a focusing operation; an aperture section 43 for adjusting an aperture or opening; an aperture drive control section 42 for drive-controlling the aperture section 43; and a lens microcomputer 40 serving as a lens control section for controlling operation of the interchangeable lens 2.

The focus lens drive control section 41 drive-controls a focus lens group (a second group lens L2) for mainly adjusting a focus.

The lens microcomputer 40 is a control unit that plays role in the interchangeable lens 2, and is connected to each part provided in the interchangeable lens 2. More specifically, the lens microcomputer 40 is provided with a CPU (Central Processing Unit), a ROM (Read Only Memory), and a RAM (Random Access Memory), and various functions can be implemented by reading programs, stored in the ROM, into the CPU. Moreover, a body microcomputer 10 and the lens microcomputer 40 are electrically connected to each other through electric contact pieces (not shown) provided in the lens mount 71, so that the body microcomputer 10 and the lens microcomputer 40 can send and receive information to and from each other.

Moreover, various information (lens information) regarding the interchangeable lens 2 is stored in a memory section (not shown) in the lens microcomputer 40.

The imaging optical system L of the interchangeable lens 2 is a system using a four-group zoom optical system, and has a first group lens L1, a second group lens L2, a third group lens L3, and a fourth group lens L4. The first group lens L1, the second group lens L2, the third group lens L3, and the fourth group lens L4 are lens groups that move on the optical axis AZ to change the magnification of an object image (hereinafter also referred to as the “magnification changing operation”), where the second group lens L2 is a lens group that moves on the optical axis AZ for focusing, that is, a focus lens group.

Moreover, the interchangeable lens 2 includes a fixed frame 50, a first-second group linearly moving frame 52, a first-second group rotary frame 53, a first group holder 54, a third-fourth group rotary frame 55, a first group lens holding frame 57, a second group lens holding frame 58, a third group lens holding frame 59, a fourth group lens holding frame 60, a second group holder 61, a filter mount 62, a zoom ring unit 63, a focus ring unit 66, and a lens mount 71.

Three through linear movement grooves 50a, for moving the first-second group moving frame 52 in a direction parallel to the optical axis AZ, are formed in the fixed frame 50 in the direction parallel to the optical axis AZ. Moreover, in the fixed frame 50, three through cam grooves 50b, for moving the third-fourth group rotary frame 55 in the direction parallel to the optical axis AZ, are formed obliquely with respect to the optical axis AZ at approximately 120° intervals in a circumferential direction, in a region that does not interfere with the through linear movement grooves 50a.

The first-second group linearly moving frame 52 is a cylindrical cam ring, and is positioned coaxially on the outer periphery side of the fixed frame 50. As described in detail below, this first-second group linearly moving frame 52 is supported by the fixed frame 50, the third-fourth group rotary frame 55, and the third group lens holding frame 59. In the first-second group linearly moving frame 52, three through linear movement grooves 52b, extending parallel to the optical axis AZ, are formed at intervals in the circumferential direction. Moreover, in the first-second group linearly moving frame 52, three through linear movement grooves 52c, extending parallel to the optical axis AZ, are formed at intervals in the circumferential direction at positions that do not interfere with the through linear movement grooves 52b. Furthermore, through holes 52d are provided in a rearmost end of the first-second group linearly moving frame 52.

As described in detail below, in the first-second group linearly moving frame 52 configured in this manner, movement of the frame 52 in a rotation direction about the optical axis AZ is restricted by the fixed frame 50, and also, the first-second group linearly moving frame 52 moves linearly in the direction parallel to the optical axis AZ as the first-second group rotary frame 53 rotates in the direction about the optical axis AZ.

The first-second group rotary frame 53 is a cylindrical cam ring, and is positioned coaxially on the outer periphery side of the first-second group linearly moving frame 52. This first-second group rotary frame 53 is supported so as to be relatively rotatable about the optical axis AZ (a Z axis direction).

Three through cam grooves 53a, extending obliquely with respect to an optical axis AZ direction, are formed in the first-second group rotary frame 53. Moreover, in the first-second group rotary frame 53, three through cam grooves 53b, extending obliquely with respect to the optical axis AZ direction, are formed at positions that do not interfere with the through cam grooves 53a. Moreover, an elongated hole 53c, which extends parallel to the optical axis AZ and opens at a rearmost edge of the first-second group rotary frame 53, is formed in a rearmost end of the first-second group rotary frame 53.

The first group holder 54 is coaxially supported outside the first-second group linearly moving frame 52 and the first-second group rotary frame 53. The first group lens holding frame 57 is provided on a front end of the first group holder 54. This first group lens holding frame 57 holds the first group lens L1. The filter mount 62 is also provided on the front end of the first group holder 54 so as to surround the outer periphery of the first group lens holding frame 57. This filter mount 62 has a cylindrical shape, and is internally threaded in order to attach an optical filter, such as a polarizing filter or a protection filter, and a conversion lens in the positive direction of the optical axis (on the object side). The filter mount 62 is fixed to the first group holder 54 by three attaching screws or the like from the object side of the optical axis AZ (the positive direction of the Z axis).

Moreover, through holes 54b, for attaching cam pins 54a from the outer periphery side, are formed at three locations (e.g., at 120° intervals) in a rear end of the first group holder 54. The cam pins 54a are respectively attached to the through holes 54b so as to protrude on the inner periphery side of the first group holder 54. The cam pins 54a extend through the through cam grooves 53a of the first-second group rotary frame 53, and fit in the through linear movement grooves 52b of the first-second group linearly moving frame 52, respectively.

That is, since the cam pins 54a fit in the through linear movement grooves 52b of the first-second group linearly moving frame 52, whose movement in the rotation direction about the optical axis AZ is restricted by the fixed frame 50, rotation of the cam pins 54a about the optical axis AZ is restricted. When the first-second group rotary frame 53 rotates about the optical axis AZ in this state, the cam pins 54a move relatively in the through cam grooves 53a of the first-second group rotary frame 53, since rotation of the cam pins 54a about the optical axis AZ is restricted by the through linear movement grooves 52b. As a result, the cam pins 54a move along the through linear movement grooves 52b in the direction parallel to the optical axis AZ. That is, when the first-second group rotary frame 53 rotates about the optical axis AZ, the first group holder 54 moves linearly in the direction parallel to the optical axis AZ.

The third-fourth group rotary frame 55 is positioned coaxially on the inner periphery side of the fixed frame 50, and is supported by the fixed frame 50. In this third-fourth group rotary frame 55, three through cam grooves 55c, extending obliquely with respect to the optical axis AZ direction, are formed at approximately 120° intervals in the circumferential direction. Moreover, in the third-fourth group rotary frame 55, three through cam grooves 55d, extending obliquely with respect to the optical axis AZ direction, are formed at approximately 120° intervals in the circumferential direction.

Moreover, three holes 55b for attaching cam pins 55a are provided in the outer peripheral surface of the three-fourth group rotary frame 55. The cam pins 55a are respectively fixed in the holes 55b so as to protrude to the outer periphery side of the third-fourth group rotary frame 55. The cam pins 55a respectively fit in the through cam grooves 50b of the fixed frame 50. One of the three cam pins 55a is longer than the other two. Only the long one of the cam pins 55a extends through the through cam 50b of the fixed frame 50, and fits in the elongated hole 53c of the first-second group rotary frame 53.

As described above, one of the cam pins 55a fits in the elongated hole 53c of the first-second group rotary frame 53. Thus, as the first-second group rotary frame 53 rotates about the optical axis AZ, the third-fourth group rotary frame 55 also rotates about the optical axis Z, integrally with the first-second group rotary frame 53. At this time, since the cam pins 55a fit in the through cam grooves 50b of the fixed frame 50, the third-fourth group rotary frame 55 rotates about the optical axis AZ while being guided by the through cam grooves 50b of the fixed frame 50, and as a result, move in the direction parallel to the optical axis AZ. That is, as the first-second group rotary frame 53 rotates about the optical axis AZ, the third-fourth group rotary frame 55 moves in the direction parallel to the optical axis AZ, while rotating about the optical axis AZ.

The second group holder 61 is supported coaxially inside the first-second group linearly moving frame 52. Moreover, holes 61b for attaching cam pins 61a from the outer periphery side are formed at three locations (e.g., at 120° intervals) in the outer periphery of the second group holder 61. The cam pins 61 a are respectively attached to the holes 61 b so as to protrude to the outer periphery side of the second group holder 61. The cam pins 61 a extend through the through linear movement grooves 52c of the first-second group linearly moving frame 52, and fit in the through cam grooves 53b of the first-second group rotary frame 53, respectively.

That is, since the cam pins 61a fit in the through linear movement grooves 52b of the first-second group linearly moving frame 52, whose movement in the rotation direction about the optical axis AZ is restricted by the fixed frame 50, rotation of the cam pins 61a about the optical axis AZ is restricted. When the first-second group rotary frame 53 rotates about the optical axis AZ in this state, the cam pins 61 a move relatively in the through cam grooves 53a of the first-second group rotary frame 53, since rotation of the cam pins 61a about the optical axis AZ is restricted. As a result, the cam pins 61a move along the through linear movement grooves 52b in the direction parallel to the optical axis AZ. That is, when the first-second group rotary frame 53 rotates about the optical axis AZ, the second group holder 61 moves linearly in the direction parallel to the optical axis AZ.

The second group lens holding frame 58 is supported by the second group holder 61 so as to be movable linearly in the direction parallel to the optical axis AZ. This second group lens holding frame 58 holds the second group lens L2. The second group lens holding frame 58 is provided with an ultrasonic actuator unit 80 that will be described below.

The third group lens holding frame 59 is positioned coaxially inside the third-fourth group rotary frame 55. The third group lens holding frame 59 holds the third group lens L3. A guide portion 59c, extending rearwards in the direction parallel to the optical axis AZ, is provided in the third group lens holding frame 59.

Moreover, holes 59b for attaching cam pins 59a are formed at three positions (e.g., at 120° intervals) in the outer periphery of the third group lens holding frame 59. The cam pins 59a are respectively fixedly press fitted in the holes 59b so as to protrude to the outer periphery side of the third group lens holding frame 59. The cam pins 59a extend through the through cam grooves 55c of the third-fourth group rotary frame 55 and the through linear movement grooves 50a of the fixed frame 50, and fit in the through holes 52d of the first-second group linearly moving frame 52, respectively.

That is, since the cam pins 59a fit in the through linear movement grooves 50a of the fixed frame 50, rotation of the cam pins 59a about the optical axis AZ is restricted. When the third-fourth group rotary frame 55 rotates about the optical axis AZ in this state with rotation of the first-second group rotary frame 53, the cam pins 59a move relatively in the through cam grooves 55c of the third-fourth group rotary frame 55, since rotation of the cam pins 59a about the optical axis AZ is restricted. As a result, the cam pins 59a move along the through linear movement grooves 50a in the direction parallel to the optical axis AZ. That is, as the first-second group rotary frame 53 rotates, the third group lens holding frame 59 moves linearly in the direction parallel to the optical axis AZ.

At this time, since the cam pins 59a fit also in the through holes 52d of the first-second group linearly moving frame 52, the first-second group linearly moving frame 52 moves integrally with the cam pins 59a. That is, as the first-second group rotary frame 53 rotates, the first-second group linearly moving frame 52 moves linearly in the direction parallel to the optical axis AZ. In other words, movement of the first-second group linearly moving frame 52 in the rotation direction about the optical axis AZ is restricted, since the cam pins 59a, whose rotation about the optical axis AZ is restricted by the through linear movement grooves 50a of the fixed frame 50, fit in the through holes 52d of the first-second group linearly moving frame 52.

The fourth group lens holding frame 60 is positioned coaxially inside the third-fourth group rotary frame 55. This fourth group lens holding frame 60 holds the fourth group lens L4. Moreover, holes 60b for attaching cam pins 60a are formed at three locations (e.g., at 120° intervals) in the outer periphery of the fourth group lens holding frame 60. The cam pins 60a are respectively fixedly press fitted in the holes 60b so as to protrude to the outer periphery of the fourth group lens holding frame 60. The cam pins 60a respectively fit in the through cam grooves 55d of the third-fourth group rotary frame 55. Moreover, a guide hole 60c is formed in the fourth group lens holding frame 60. A guide portion 59c of the three-group lens holding frame 59 fits in the guide hole 60c.

That is, since the guide portion 59c of the third group lens holding frame 59, whose rotation about the optical axis AZ is restricted, fits in the guide hole 60c, rotation of the fourth group lens holding frame 60 about the optical axis AZ is restricted. When the third-fourth group rotary frame 55 rotates about the optical axis AZ in this state with rotation of the first-second group rotary frame 53, the cam pins 60a move relatively in the through cam grooves 55d of the third-fourth group rotary frame 55, with rotation of the cam pins 60a about the optical axis AZ being restricted. As a result, the cam pins 60a move along the extending direction of the guide hole 60c and the guide portion 59c, in the direction parallel to the optical axis AZ. That is, as the first-second group rotary frame 53 rotates, the fourth group lens holding frame 60 moves linearly in the direction parallel to the optical axis AZ.

The ring unit 72 includes a zoom ring unit 63, a focus ring unit 66, a ring base 69, and a mount base 70.

The zoom ring unit 63 has a zoom ring 64, and a zoom ring angle detection section 65 for detecting the rotation angle of the zoom ring 64. The zoom ring 64 has a cylindrical shape, and is supported by the ring base 69 fixed to the fixed frame 50 so as to be rotatable about the optical axis AZ, while being restricted in movement in the direction parallel to the optical axis AZ. Moreover, the zoom ring 64 has a recessed portion (not shown) in its inner peripheral portion, where the recessed portion is restricted only about the optical axis AZ, which is not shown, and is not restricted in the direction parallel to the optical axis AZ, and the recessed portion engages with a protruding portion (not shown) provided on the outer periphery of the first-second group rotary frame 53. Thus, the first-second group rotary frame 53 rotates when the operator or the like rotates the zoom ring 64. Moreover, the zoom ring angle detection section 65 transmits focal length information to the lens microcomputer 40 by detecting the rotation angle and the rotation direction of the zoom ring 64 rotated by the operator or the like. Moreover, the focal length of the imaging optical system is indicated on the outer peripheral surface of the zoom ring 64. Note that respective absolute positions of the lens groups L1 through L4 can be detected by a detection sensor, not shown, which operates according to the rotation angle of the zoom ring 64. The zoom ring 64 is an example of a zoom operation section that is operated by the operator. The zoom operation section may be a movable lever or the like. Moreover, the first-second group linearly moving frame 52, the first-second group rotary frame 53, the first group holder 54, the second group lens holding frame 58, and the like are an example of a zoom mechanism for mechanically transmitting operation of the zoom operation section to the lens groups for changing the magnification, and moving the lens groups for changing the magnification, in the optical axis direction.

The focus ring unit 66 has a focus ring 67, and a focus ring angle detection section 68 for detecting the rotation angle of the focus ring 67. The focus ring 67 has a cylindrical shape, and is supported by the ring base 69 fixed to the fixed frame 50 so as to be rotatable, without limit, about the optical axis AZ, while being restricted in movement in the direction parallel to the optical axis AZ. Moreover, the rotation angle and the rotation direction of the focus ring 67 can be detected by the focus ring angle detection section 68. For example, when projections which are formed on the entire circumference of the focus ring 67 at regular intervals and extend in the direction parallel to the optical axis AZ pass between a light emitting section and a light receiving section which are two constituent parts of the photo sensor that are not shown, this focus ring angle detection section 68 detects the passage of the projections, and thus, detects the rotation angle and the rotation direction of the focus ring 67. The focus ring angle detection section 68 transmits object point distance information to the lens microcomputer 40 by detecting the rotation angle and the rotation direction of the focus ring 67 rotated by the operator or the like. The focus ring 67 is an example of a focus operation section that is operated by the operator. The focus operation section may be a movable lever or the like.

The lens mount 71 has a lens mount contact point, not shown, and transmits signals between the lens microcomputer 40 and the body microcomputer 10 through a lens mount contact point, not shown, of the body mount 4. Moreover, the lens mount 71 is fixed by the fixed frame 50 and the mount base 70.

The interchangeable lens 2 further includes a focus lens unit 78 that is movable in the direction parallel to the optical axis AZ according to the focusing operation. This focus lens unit 78 has the second group lens L2, the second group lens holding frame 58, the second group holder 61, guide poles 74a, 74b, a second group fixed frame 75, the ultrasonic actuator unit 80, a magnetic scale 76, and a magnetic sensor 77. This focus lens unit 78 forms a focus unit.

The second group holder 61 and the second group fixed frame 75 are formed in an annular shape, and are positioned so as to face each other with their respective axial centers being aligned with each other.

The guide poles 74a, 74b are positioned between the second group holder 61 and the second group fixed frame 75 so as to extend parallel to the optical axis AZ, and both ends of each guide pole 74a, 74b are supported by the second group holder 61 and the second group fixed frame 75, respectively.

The second group fixed frame 75 is shaped so that recessed portions 75a, 75b, which are recessed in the direction parallel to the optical axis AZ, are formed at two locations in an annular body. The second group fixed frame 75 supports respective one ends of the guide poles 74a, 74b in these two recessed portions 75a, 75b, respectively.

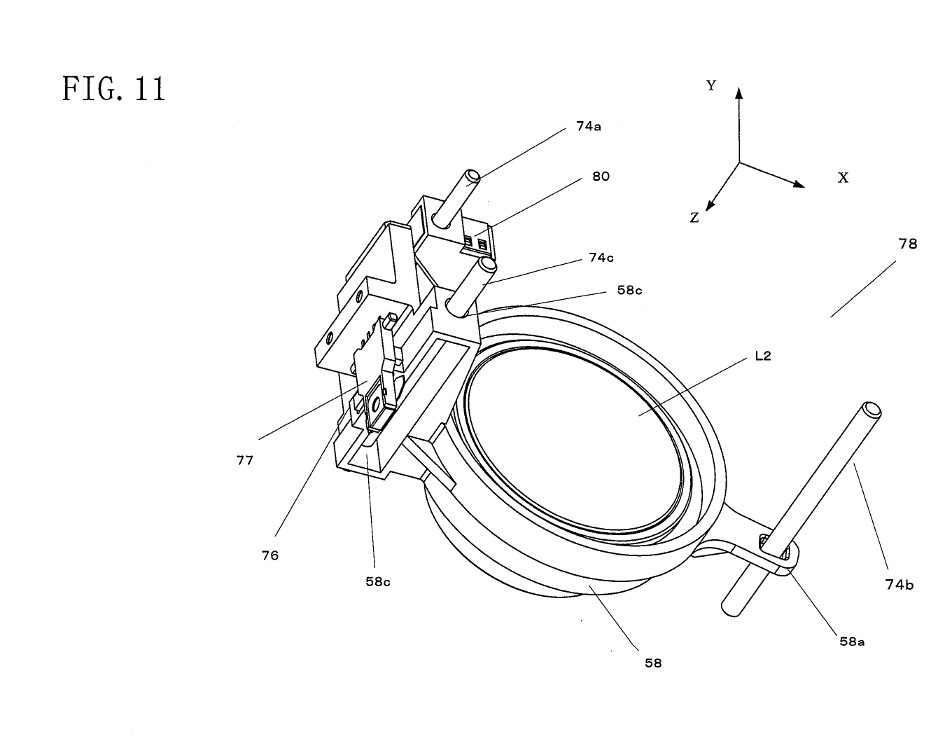

The second group lens holding frame 58 holds the second group lens L2 (the focus lens group), and is configured to be slidable in the direction parallel to the optical axis AZ along the guide poles 74a, 74b, which are disposed in the direction parallel to the optical axis AZ, and both ends of which are fixed between the second group holder 61 and the second group fixed frame 75. More specifically, the second group lens holding frame 58 has: an annular holder main body 58d for holding the second group lens L2; a rotation stopper 58a (see FIG. 11) provided on the holder main body 58d, for inserting the guide pole 74b therethrough; and a fixed portion 58b provided on the holder main body 58d on the side opposite to the rotation stopper 58a with the optical axis AZ interposed therebetween, for attaching the ultrasonic actuator unit 80. The rotation stopper 58a is provided so as to protrude radially outwards from the holder main body 58d, and has a through hole formed to insert the guide pole 74b therethrough. The fixed portion 58b is a flat-plate shaped member provided so as to protrude in the direction parallel to the optical axis AZ from the holder main body 58d. The magnetic scale 76, which is magnetized at equal intervals in the direction parallel to the optical axis AZ, is attached to the fixed portion 58b.

Moreover, the magnetic sensor 77 is formed by an MR (magnetoresistive) sensor for detecting a signal of the magnetic scale 76, or the like. This magnetic sensor 77 is fixed to the second group fixed frame 75 so as to face the magnetic scale 76 with a predetermined gap being maintained therebetween.

The magnetic scale 76 and the magnetic sensor 77 form position detecting means.

The ultrasonic actuator unit 80 is formed by a movable portion 80a and a fixed portion 80b, and drives the second group lens holding frame 58 in the direction parallel to the optical axis AZ. The movable portion 80a of the ultrasonic actuator unit 80 is attached, by screwing or the like, to the fixed portion 58b provided in the second group lens holding frame 58. Thus, as described in detail below, the ultrasonic actuator unit 80 is designed to drive the second group lens holding frame 58 in the direction parallel to the optical axis AZ as the movable portion 80a of the ultrasonic actuator unit 80 moves in the direction parallel to the optical axis AZ when a predetermined current is applied to the ultrasonic actuator unit 80.

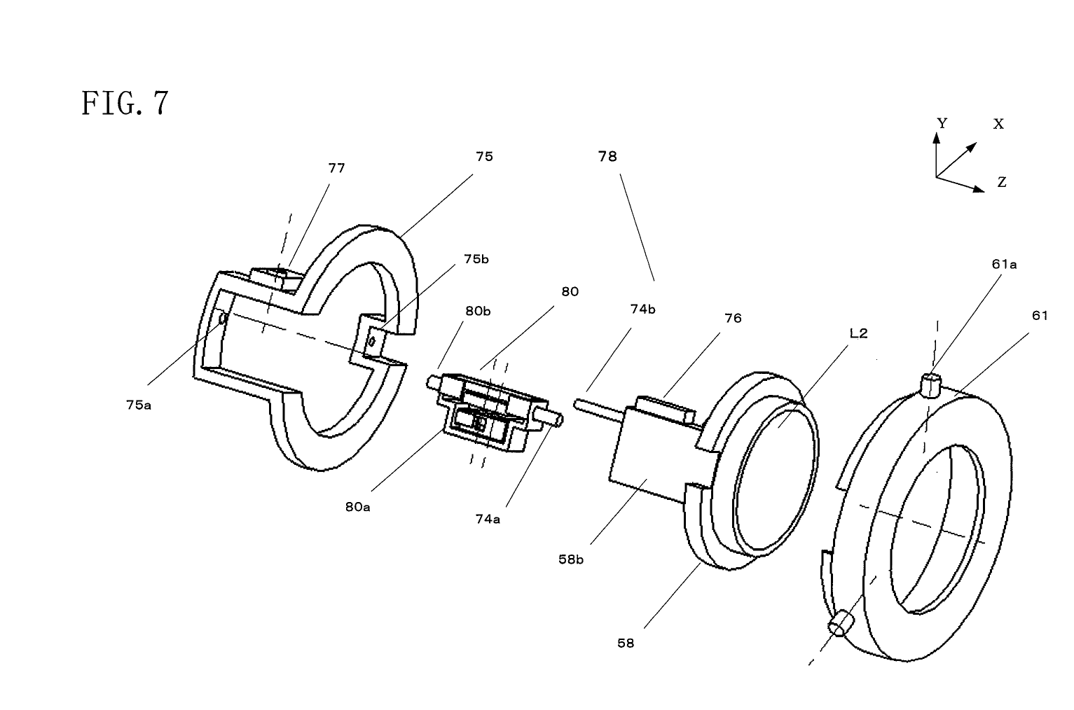

Next, the ultrasonic actuator unit 80 will be described with reference to FIGS. 7 through 10.

The ultrasonic actuator unit 80 is formed by: the movable portion 80a, which is formed by a piezoelectric element 81, driver elements 82, an inner case 84, an outer case 90, guide balls 91, a retainer 92, an outer case lid 93, and the like; and the fixed portion 80b, which is formed by a sliding plate 83 and the guide pole 74a.

The piezoelectric element 81 is made of a piezoelectric material, such as PZT (lead zirconate titanate) or crystal. The driver elements 82 having an approximately spherical shape are provided at two locations on a surface of the piezoelectric element 81. The two locations are locations corresponding approximately to the center of the antinode of bending vibration of the piezoelectric element 81. Providing the driver elements 82 at these locations enables vibration of the piezoelectric element 81 to be effectively used.

Examples of the material of the driver elements 82 include zirconia, alumina, silicon nitride, silicon carbide, tungsten carbide, and the like. Moreover, the driver elements 82 have an approximately spherical shape, and providing the driver elements 82 having an approximately spherical shape can reduce the contact area with the piezoelectric element 81 in the longitudinal direction, whereby the bending vibration of the piezoelectric element 81 is less likely to be hindered, and as a result, the efficiency as an ultrasonic actuator can be improved.

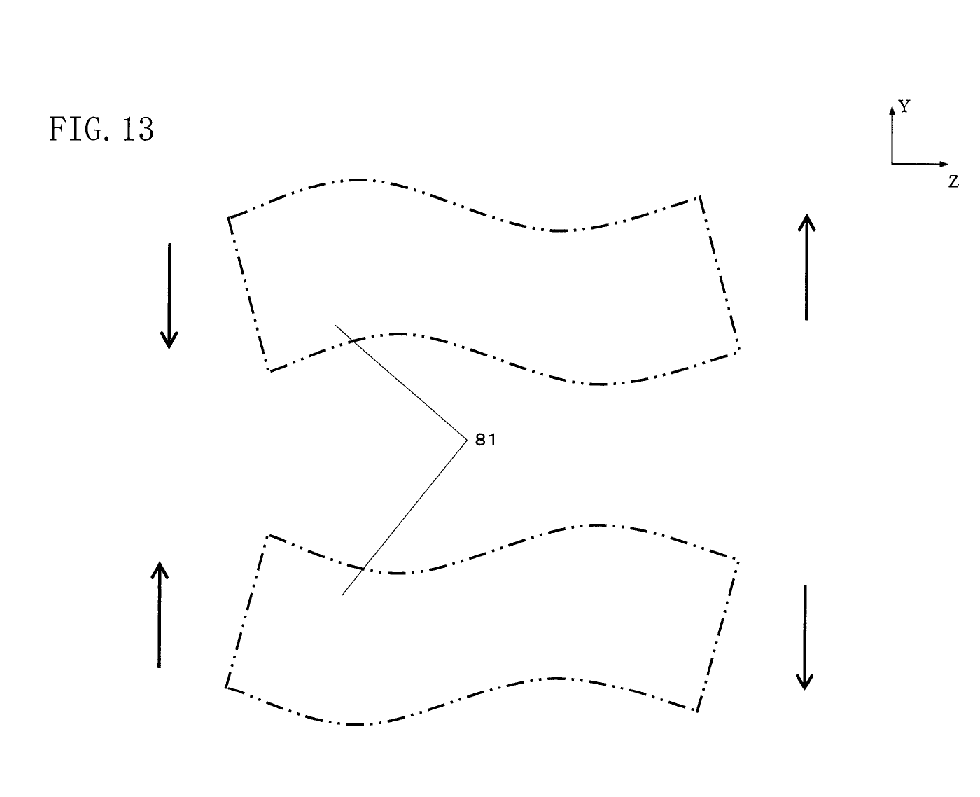

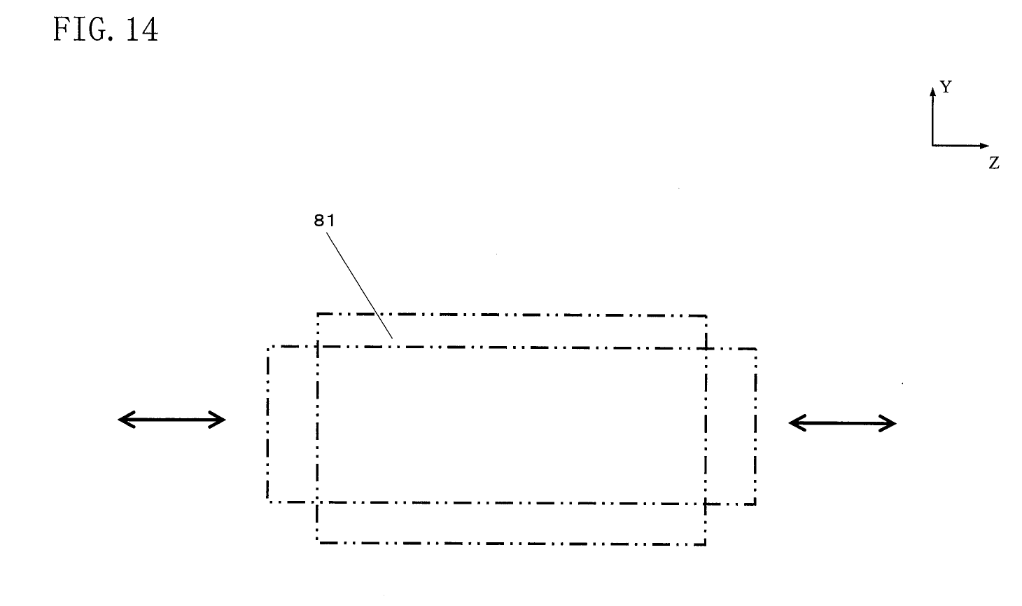

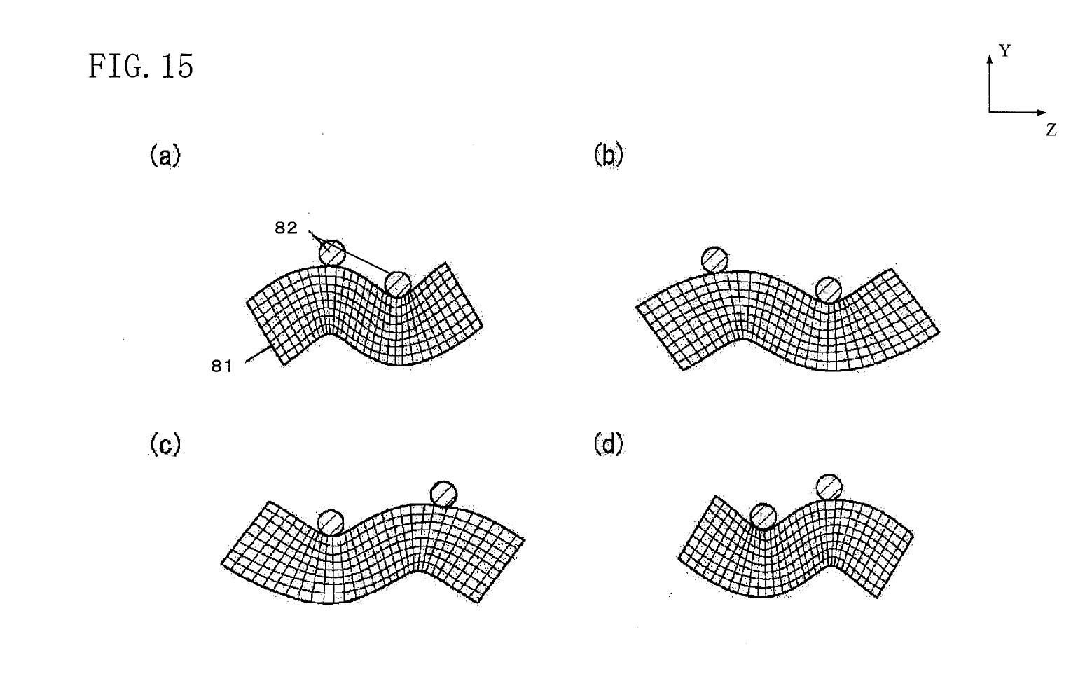

Four-divided feeding electrodes 88 are provided on the front face of the piezoelectric element 81. Wires 89 are connected to the feeding electrodes 88 by solder 86. The wires 89 are extended to the outside via through holes (not shown) provided in the inner case 84. By applying a voltage to the feeding electrodes 88 of the piezoelectric element 81 through the wires 89, the piezoelectric element 81 vibrates according to the frequency of the applied voltage. In the present embodiment, a second order mode of bending vibration shown in FIG. 13, and a first order mode of stretching vibration shown in FIG. 14 are induced in the piezoelectric element 81 by applying an alternating current (AC) voltage of a specific frequency to a specific feeding electrode of the piezoelectric element 81. The resonance frequency of the bending vibration and the resonance frequency of the stretching vibration are determined by the material, shape, and the like of the piezoelectric element 81. However, the bending second order mode and the stretching first order mode are harmonically induced in the piezoelectric element 81 by setting these two frequencies to approximately the same value, and applying a voltage of a frequency close to that value. At this time, by using every two feeding electrodes 88, 88 positioned in a diagonal direction as a set, and by applying two voltages of the above frequency, having an equal voltage value and having a phase difference of 90° from each other, to the two sets of feeding electrodes 88, 88, respectively, the stretching first order mode in the longitudinal direction (the Z axis direction) and the bending second order mode in the lateral direction (the Y axis direction) are induced in the piezoelectric element 81, so that the shape of the piezoelectric change 81 changes sequentially in the order of FIGS. 15(a) through 15(d).

Because of this vibration of the piezoelectric element 81, the driver elements 82 provided in the piezoelectric element 81 generate an approximately elliptical motion (i.e., a circulating motion), as viewed from the direction perpendicular to the plane of the page of the figure. That is, the driver elements 82 generate an elliptical motion by combination of the bending vibration and the stretching vibration of the piezoelectric element 81.

Note that a part of the piezoelectric element 81, where the solder 86 is formed, is around respective node portions of the stretching vibration and the bending vibration. By using the node portions as a part for connecting the wires 89, an adverse effect on vibration of the piezoelectric element 81, that is, an unnecessary load that is applied to the piezoelectric element 81 by formation of the solder 86, is suppressed as much as possible.

The piezoelectric element 81 is accommodated in the inner case 84. In this case, the driver elements 82, 82 protrude from the inner case 84 to the outside.

Moreover, the piezoelectric element 81 is supported by a support body 85 provided in the inner case 84. The support body 85 is made of, e.g., a conductive silicone rubber.

More specifically, wall surface support bodies 85a, 85c are respectively provided on the inner wall surfaces of the inner case 84, which respectively face the side surfaces of the piezoelectric element 81 facing toward the longitudinal direction thereof, so that a lateral pressure (a pressure in the longitudinal direction) is applied to the piezoelectric element 81. A rear support body 85b is also provided on the inner wall surface (the inner bottom surface) of the inner case 84, which faces the side surface of the piezoelectric element 81 facing toward the lateral direction thereof and has no driver element 82 provided thereon, so that the piezoelectric element 81 is supported, and the piezoelectric element 81 is pressed. The rear support body 85b is provided so that the two driver elements 82 contact the sliding plate 83, described in detail below, with approximately the same pressure, whereby stable operation can be implemented.

Moreover, the inner case 84 is fixed inside the outer case 90. Bearing portions 90a, 90b for supporting the guide pole 74a are formed on both end sides of the outer case 90 in the direction parallel to the optical axis AZ. The outer case 90 is configured to be slidable with respect to the guide pole 74a. The inner case 84 is fixed to the outer case 90 so that the sliding plate 83 is positioned between the driver elements 82, 82, and the guide pole 74a. Moreover, the two guide balls 91, which are held by the retainer 92, are positioned on the upper side of the guide pole 74a (on the side opposite to the sliding plate 83). Moreover, the outer case lid 93 is fixed to the outer case 90 so as to press the guide balls 91 toward the guide pole 74a. Thus, the guide pole 74a and the sliding plate 83 are pressed to be fixed to each other with a predetermined pressure. Note that the sliding plate 83 may be bonded to the guide pole 74a.

An example of the material of the sliding plate 83 is an alumina. In the case of using an alumina for the driver elements 82, it is desirable that an alumina softer than the alumina of the driver elements 82 be used for the sliding plate 83, in view of wearing. That is, the piezoelectric element 81 is positioned so that the vibration direction of the stretching vibration of the piezoelectric element 81 becomes the same as an axial direction of the guide pole 74a (the direction parallel to the optical axis AZ), and the vibrating direction of the bending vibration of the piezoelectric element 81 becomes perpendicular to the axial direction of the guide pole 74a.

The outer case 90 is attached to the fixed portion 58b of the second group lens holding frame 58.

The piezoelectric element 81, the driver elements 82, the support body 85, the inner case 84, and the like form an ultrasonic actuator. The outer case 90, and also, the outer case lid 93, the second group lens holding frame 58, and the second group lens L2, which are formed integrally with the outer case 90, form a movable body, and the sliding plate 83 and the guide pole 74a form a fixed body. That is, the ultrasonic actuator, formed by the piezoelectric element 81 and the like, is attached to the outer case 90 that is the movable body, and is configured to be movable together with the outer case 90 and the like, relative to the sliding plate 83 and the guide pole 74a which form the fixed body.

Next, operation of the ultrasonic actuator unit 80 of the above configuration will be described. The second order mode of the bending vibration and the first order mode of the stretching vibration are induced in the piezoelectric element 81 by applying an AC voltage of a specific frequency to a specific feeding electrode of the piezoelectric element 81. As a result, the driver elements 82, provided in the piezoelectric element 81, generate an elliptical motion as viewed from the direction perpendicular to the plane of the page of the figure.

The driver elements 82, which generate a circulating motion in this manner, generate a circulating motion while increasing a frictional force with the sliding plate 83, in one region, and generate a circulating motion while reducing the frictional force with the sliding plate 83, in another region. As a result, when the frictional force with the sliding plate 83 increases, the piezoelectric element 81 having the driver elements 82 move relative to the sliding plate 83 and the guide pole 74a, which form the fixed body. As a result, the inner case 84 accommodating the piezoelectric element 81, and the outer case 90 to which the inner case 84 is attached, and also, the second group lens L2 move along the guide pole 74a in the direction parallel to the optical axis AZ.

That is, by the elliptical motion of the driver elements 82, the movable portion 80a, which is formed by the piezoelectric element 81, the driver elements 82, the outer case 90, and the like, moves in the direction parallel to the optical axis AZ, with respect to the sliding plate 83 and the guide pole 74a. Since the fixed portion 58b of the second group lens holding frame 58 is attached to the movable portion 80a, the second group lens holding frame 58 also moves in the direction parallel to the optical axis AZ, integrally with the movable portion 80a. That is, the ultrasonic actuator unit 80 serves as an ultrasonic actuator having a self-propelled configuration, which reciprocatively moves integrally with the focus lens group in the direction parallel to the optical axis AZ.

In this case, by performing position detection by the magnetic sensor 77 to perform feedback control, a linear actuator having high resolution, high accuracy, low noise, and high torque, in addition to a fast response property, can be configured, whereby excellent focus characteristics (as the camera system 1 described below) can be obtained. Note that the origin position of the second group lens L2, that is, the second group lens holding frame 58, can be detected by a photosensor, not shown, or the like. Moreover, regarding a relative position from the origin position, the position of the second group lens L2 can be constantly detected by counting an output value from the magnetic sensor 77.

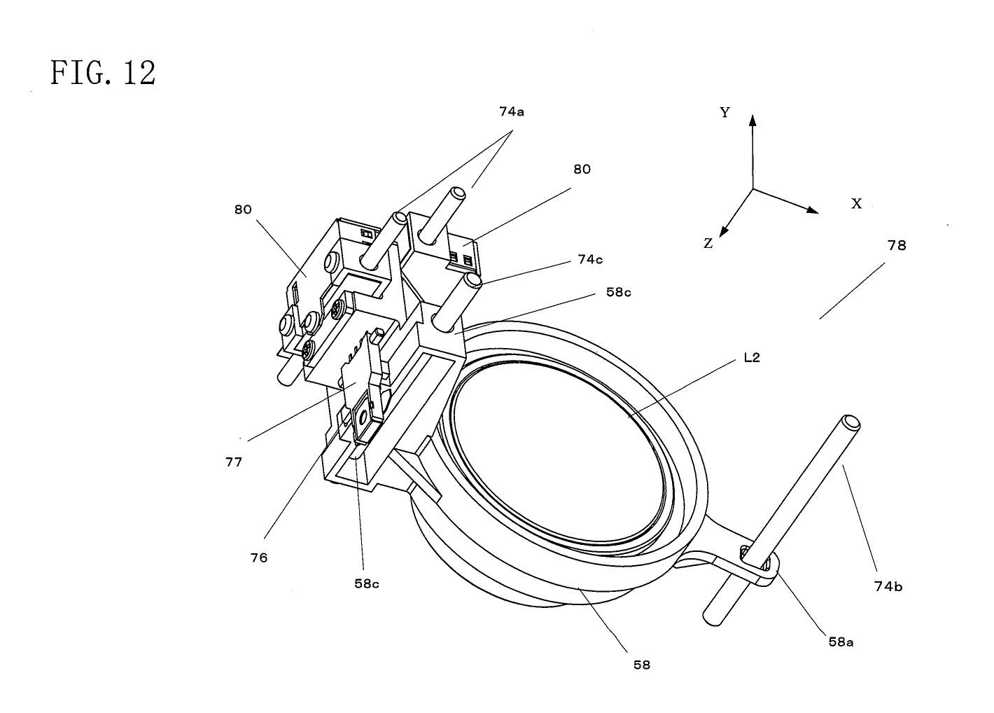

Moreover, the focus lens unit may have other configurations as shown in FIGS. 11 and 12.

In the configuration of the focus lens unit 78 shown in FIG. 11, a guide pole 74c is provided instead of the guide pole 74a supporting the ultrasonic actuator unit 80, as a guide pole 74 supporting the second group lens holding frame 58 in the direction parallel to the optical axis AZ. Since both ends of the guide pole 74c are supported by two bearing portions 58c provided on the second group lens holding frame 58, a plane perpendicular to the optical axis AZ is uniquely determined by three points including the rotation stopper 58a. Thus, since there is no influence of inclination of the guide pole 74a with respect to the optical axis AZ due to variation in attachment of the ultrasonic actuator unit 80 to the second group lens holding frame 58, or the like, the second group lens L2 can be more accurately supported in the direction parallel to the optical axis AZ. Note that, in this configuration, both ends of the guide pole 74a for the ultrasonic actuator unit 80 are biased by a leaf spring or the like only in the direction parallel to the optical axis AZ, and are allowed to have a degree of freedom in other directions, whereby this configuration does not adversely affect the position accuracy determined by the guide poles 74b, 74c.

Moreover, the configuration of the focus lens unit 78 shown in FIG. 12 is obtained by adding another ultrasonic actuator unit 80 to the configuration of FIG. 11. By driving the second group lens holding frame 58 by two ultrasonic actuator units 80, the second group lens holding frame 58 can be driven with a sufficient margin even for, e.g., an optical system having a heavy focus lens group, such as a high magnification lens.

Note that, instead of the ultrasonic actuator unit 80, an electromagnetic linear actuator or a stepping motor may be used as an actuator for reciprocatively moving the second group lens L2 in the direction parallel to the optical axis AZ.

Regarding the electromagnetic linear actuator, a coil is disposed on the movable portion side where the second group lens L2 is provided, and a magnet and a yoke are disposed on the fixed portion side, whereby the second group lens L2 can be linearly driven in the direction parallel to the optical axis AZ by applying a current to the coil. Note that the coil may be disposed on the fixed portion side, and the magnet and the yoke may be disposed on the movable portion side.

Regarding the stepping motor, an engagement portion is provided on the movable portion side where the second group lens L2 is provided, and a lead screw, which engages with the engagement portion, is provided on the fixed portion side, thereby configuring the stepping motor. This stepping motor can linearly drive the second group lens L2 in the direction parallel to the optical axis AZ by rotating the lead screw, and converting the rotation motion to a linear motion by the engagement portion.

(1.2: Camera Main Body)

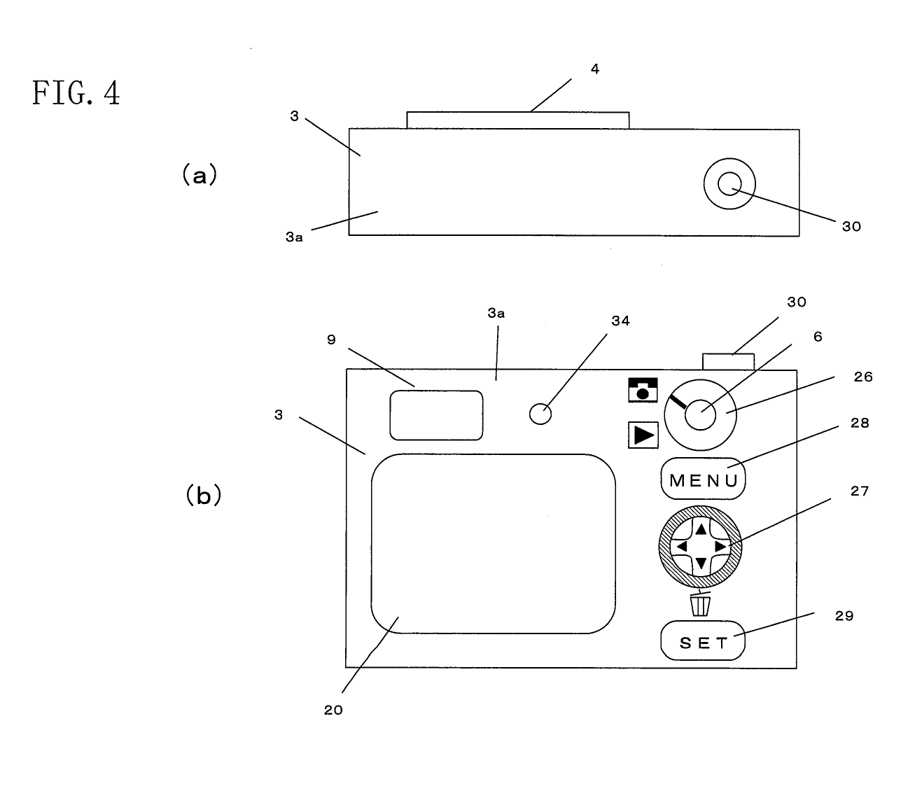

In FIG. 4, a housing 3a of the camera main body 3 is supported by the operator or the like when shooting an object. The body mount 4 is provided on the front face of the housing 3a. A display section 20, a power switch 25, a shooting/playback mode switching section 26, and a cross operation key 27, and a MENU setting operation section 28, and a SET operation section 29 are provided on the rear face of the housing 3a. A shutter operation section 30 is provided on the top face of the housing 3a.

The body mount 4 is mechanically and electrically connectable with the lens mount 71 of the interchangeable lens 2. The body mount 4 is capable of transmitting and receiving data to and from the interchangeable lens 2 via the lens mount 71. The body mount 4 transmits an exposure synchronization signal, received from the body microcomputer 10 described below, to the lens microcomputer 40 via the lens mount 71. Moreover, the body mount 4 transmits other control signals, received from the body mount 10, to the lens microcomputer 40 via the lens mount 71. Moreover, the body mount 4 transmits signals, received from the lens microcomputer 40 via the lens mount 71, to the body microcomputer 10. Furthermore, the body mount 4 supplies electric power, received from a power supply unit (not shown), to the entire interchangeable lens 2 via the lens mount 71.

The power switch 25 is an operation member for turning on and off the power of the camera system 1 or the camera maind body 3. When the power is turned on with the power switch 25, the power source is supplied to each part of the camera main body 3 and the interchangeable lens 2.

The shooting/playback mode switching section 26 is an operation member for switching the operation mode between a shooting mode and a playback mode, and the operator or the like can switch the operation mode by turning a lever.

The cross operation key 27 is an operation member whose upper, lower, right and left parts are pressed by the operator or the like to select a desired menu from various menu screens displayed on the display section 20.

The MENU setting operation section 28 is an operation member for setting various operations of the camera system 1.

The SET operation section 29 is an operation member for confirming execution of various menus.

The shutter operation section 30 is, for example, a release button that is operated by the operator or the like upon shooting. When the shutter operation section 30 is operated, a timing signal is output to the body microcomputer 10. The shutter operation section 30 is a two-stage depression switch capable of half depressing operation and full depressing operation. When the operator or the like half depresses the shutter operation section 30, the shutter operation section 30 starts photometric processing and distance measuring processing. A timing signal is output when the operator then fully depresses the shutter operation section 30.

The camera main body 3 is formed mainly by an imaging section 35 for imaging an object, the body microcomputer 10 as a main body control section for controlling operation of each part such as the imaging section 35, an image display section 36 for displaying a captured image and various information, and a finder section 38 for visually recognizing an object image.

The imaging section 35 is formed mainly by an image sensor 11, such as a CCD (Charge Coupled Device) for performing photoelectric conversion, a shutter unit 33 for adjusting the exposure state of the image sensor 11, a shutter control section 31 for controlling driving of the shutter unit 33 based on a control signal from the body microcomputer 10, and an image sensor drive control section 12 for controlling operation of the image sensor 11. For a focusing method in the present embodiment, a contrast auto-focusing (AF) method is used based on image data produced by the image sensor 11. Thus, by using the contrast method, accurate focusing operation can be implemented as a camera system.

The image sensor 11 is, for example, a CCD (Charge Coupled Device) sensor for converting an optical image formed by the imaging optical system L to an electric signal. The image sensor 11 is drive-controlled according to a timing signal generated by the image sensor drive control section 12. Note that the image sensor 11 may be a CMOS (Complementary Metal Oxide Semiconductor) sensor.

The shutter control section 31 drives a shutter drive actuator (a shutter drive motor) 32 to operate a shutter unit 33, according to a control signal, which is output from the body microcomputer 10 in response to the timing signal.

The body microcomputer 10 is a control unit that plays a central role in the camera main body 3, and controls various sequences. More specifically, the body microcomputer 10 is provided with a CPU, a ROM, and a RAM, and the body microcomputer 10 can implement various functions by reading programs, stored in the ROM, into the CPU. For example, the body microcomputer 10 has a function to detect attachment of the interchangeable lens 2 to the camera main body 3, or a function to obtain information that is essential to control the camera system 1, such as focal length information, from the interchangeable lens 2 to control the camera system 1.

The body microcomputer 10 is capable of receiving respective signals of the power switch 25, the shutter operation section 30, the shooting/playback mode switching section 26, the cross operation key 27, the MENU setting operation section 28, and the SET operation section 29. Various information about the camera main body 3 is stored in a memory section 10a in the body microcomputer 10. The body microcomputer 10 is an example of a control section of the present invention.

The body microcomputer 10 controls the entire camera system, such as the image sensor 11, according to commands from operation members such as the shutter operation section 30.

Moreover, the body microcomputer 10 regularly produces a vertical synchronization signal. At the same time, the body microcomputer 10 produces an exposure synchronization signal based on the vertical synchronization signal. The body microcomputer 10 is capable of generating an exposure synchronization signal, since the body microcomputer 10 knows in advance the exposure start timing and the exposure end timing based on the vertical synchronization signal. The body microcomputer 10 outputs the vertical synchronization signal to a timing generator (not shown), and periodically and repeatedly outputs the exposure synchronization signal to the lens microcomputer 40 via the body mount 4 and the lens mount 71. The lens microcomputer 40 obtains position information of the second group lens L2 in synchronization with the exposure synchronization signal.

The image sensor drive control section 12 regularly produces a read signal of the image sensor 11 and an electronic shutter drive signal, based on the vertical synchronization signal. The image sensor drive control section 12 drives the image sensor 11, based on the read signal and the electronic shutter drive signal. That is, the image sensor 11 transfers pixel data, produced in a multiplicity of photoelectric conversion elements (not shown) existing in the image sensor 11, to a vertical transfer section (not shown) according to the read signal.

Moreover, the body microcomputer 10 forms a control section for controlling the focus lens group via the lens microcomputer 40.

An image signal, which is output from the image sensor 11, is sequentially transmitted from an analog signal processing section 13 to an A/D conversion section 14, a digital signal processing section 15, a buffer memory 16, and an image compression section 17, and processed therein. The analog signal processing section 13 performs analog signal processing, such as gamma processing, of the image signal that is output from the image sensor 11. The A/D conversion section 14 converts an analog signal, which is output from the analog signal processing section 13, to a digital signal. The digital signal processing section 15 performs digital signal processing, such as noise removal and contour highlighting, of the image signal converted into the digital signal by the A/D conversion section 14. The buffer memory 16 is a RAM (Random Access Memory), and temporarily stores the image signal. The image signal stored in the buffer memory 16 is sequentially transmitted to the image compression section 17 and an image reading/recording section 18, and processed therein. The image signal stored in the buffer memory 16 is read according to a command of an image recording control section 19, and is transmitted to the image compression section 17. Data of the image signal transmitted to the image compression section 17 is compressed to an image signal according to a command of the image recording control section 19. This compression processing reduces the size of the data represented by the image signal than the original data. For example, a JPEG (Joint Photographic Experts Group) method for compressing an image signal on a frame-by-frame basis is used for such a compression method. Then, the compressed image signal is recorded on the image reading/recording section 18 by the image recording control section 19. In the case of recording a moving picture, a PEG method for compressing each of a plurality of image signals on a frame-by-frame basis may be used, or a H.264/ACV method for collectively compressing image signals of a plurality of frames may be used as the compression method.

The image reading/recording section 18 associates the image signal with predetermined information, which is to be recorded, to create a still picture file or a moving picture file, based on a command of the image recording control section 19. Then, the image reading/recording section 18 records the still picture file or the moving picture file based on a command of the image recording control section 19. The image reading/recording section 18 is, for example, an internal memory or a removable memory. Note that the predetermined information, which is to be recorded together with the image signal, includes the date and time the image was captured, focal length information, shutter speed information, aperture value information, and shooting mode information. The still picture file is in, e.g., an Exif (registered trademark) format, or a format similar to the Exif (registered trademark) format. Moreover, the moving picture file is in, e.g., an H.264/AVC format, or a format similar to the H.264/AVC format.

The image display section 36 has the display section 20 formed by, e.g., a liquid crystal monitor. The display section 20 displays an image signal, recorded in the image reading/recording section 18 or the buffer memory 16, as a visible image, based on a command from an image display control section 21. The display form of the display section 20 includes a display form in which only an image signal is displayed as a visible image, and a display form in which an image signal and shooting information are displayed as a visible image.

The finder potion 38 has the liquid crystal finder 8 for displaying an image signal obtained via the image sensor 11, and a finder eyepiece window 9 provided on the rear face of the housing 3a. By looking into the finder eyepiece window 9, the operator can visually recognize an image signal displayed on the liquid crystal finder 8.

[2: Operation of Camera System]

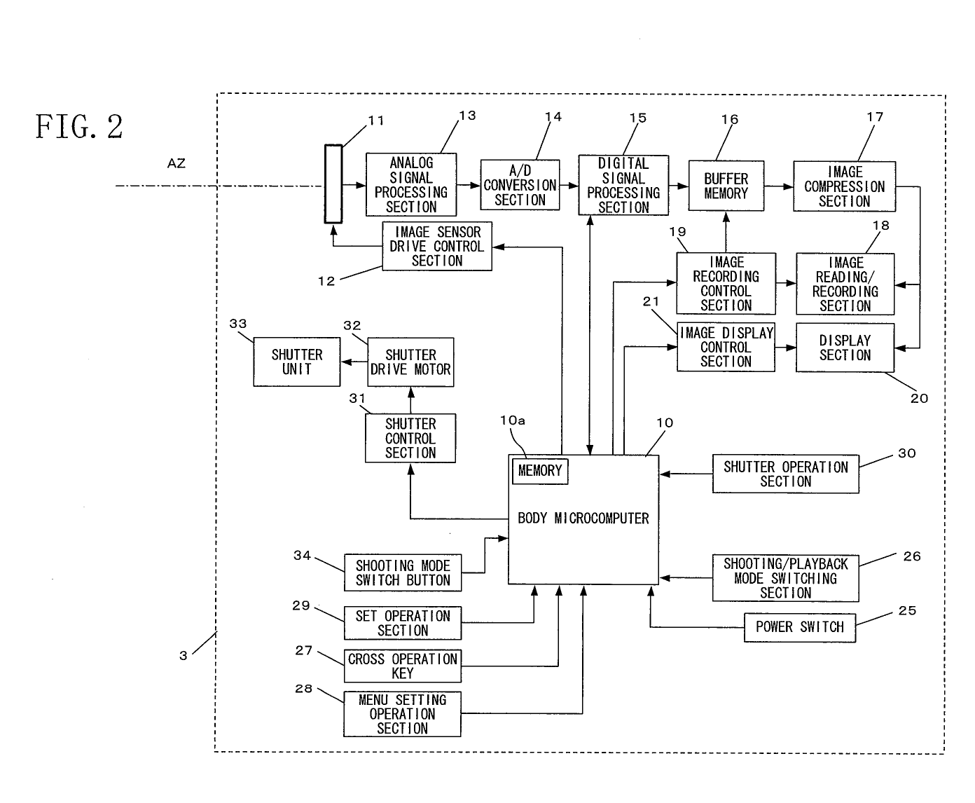

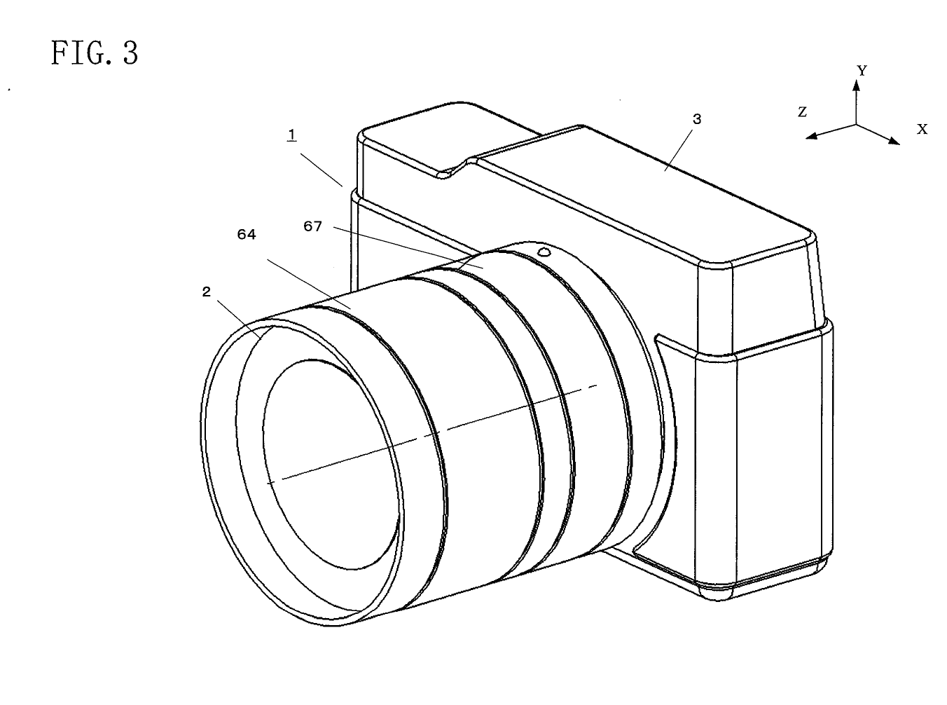

Operation of the camera system 1 will be described below with reference to FIGS. 1 through 6.

(2.1: Operation Before Imaging)

This camera system 1 has two shooting modes. One is a finder shooting mode in which the operator or the like performs shooting while observing through the finder eyepiece window 9. The image display control section 21 executes the finder shooting mode by, for example, driving the liquid crystal finder 8. An image of an object, which is a so-called through image, is displayed on the liquid crystal finder 8 via the image sensor 11. On the other hand, the image display control section 21 executes a monitor shooting mode, which is the other shooting mode, by, for example, driving the display section 20. A so-called through image is displayed on the display section 20. Note that switching between the two shooting modes can be performed by a shooting mode switch button 34.

(2.2: Operation When Capturing a Still Picture)

[Zoom Operation]

Next, operation of the interchangeable lens 2 when the operator or the like performs zoom operation will be described.

When the operator or the like rotates the zoom ring 64, the rotating motion of the zoom ring 64 is transmitted to the first-second group rotary frame 53 connected to the zoom ring 64. As the first-second group rotary frame 53 rotates about the optical axis AZ, the first-second group rotary frame 53 is guided by the cam grooves 50b of the fixed frame 50, and the first-second group rotary frame 53 moves in the direction parallel to the optical axis AZ while rotating about the optical axis AZ. Moreover, the first-second group linearly moving frame 52 linearly moves in the direction parallel to the optical axis AZ, integrally with the first-second group rotary frame 53.

As the first-second group rotary frame 53 rotates about the optical axis AZ, the cam pins 54a are guided by the cam grooves 53a, and the first group holder 54, and the first group lens holding frame 57 fixed to the first group holder 54 linearly move in the direction parallel to the optical axis AZ. Moreover, as the first-second group rotary frame 53 rotates about the optical axis AZ direction, the cam pins 61a are guided by the cam grooves 53b, and the second group holder 61 and the second group lens holding frame 58 integrally move linearly in the direction parallel to the optical axis AZ. That is, the focus lens unit 78 moves in the direction parallel to the optical axis AZ.

As the first-second group rotary frame 53 rotates about the optical axis AZ, the cam pins 55a are guided by the cam grooves 50b, and the third-fourth group rotary frame 55 rotates about the optical axis AZ, and also, moves in the direction parallel to the optical axis AZ.

As the third-fourth group rotary frame 55 rotates about the optical axis AZ, the cam pins 59a are guided by the through linear movement grooves 50a, and the third group lens holding frame 59 moves in the direction parallel to the optical axis AZ. Moreover, as the third-fourth group rotary frame 55 rotates about the optical axis AZ, the cam pins 60a are guided by the cam grooves 55d, and the fourth group lens holding frame 60 moves in the direction parallel to the optical axis AZ.

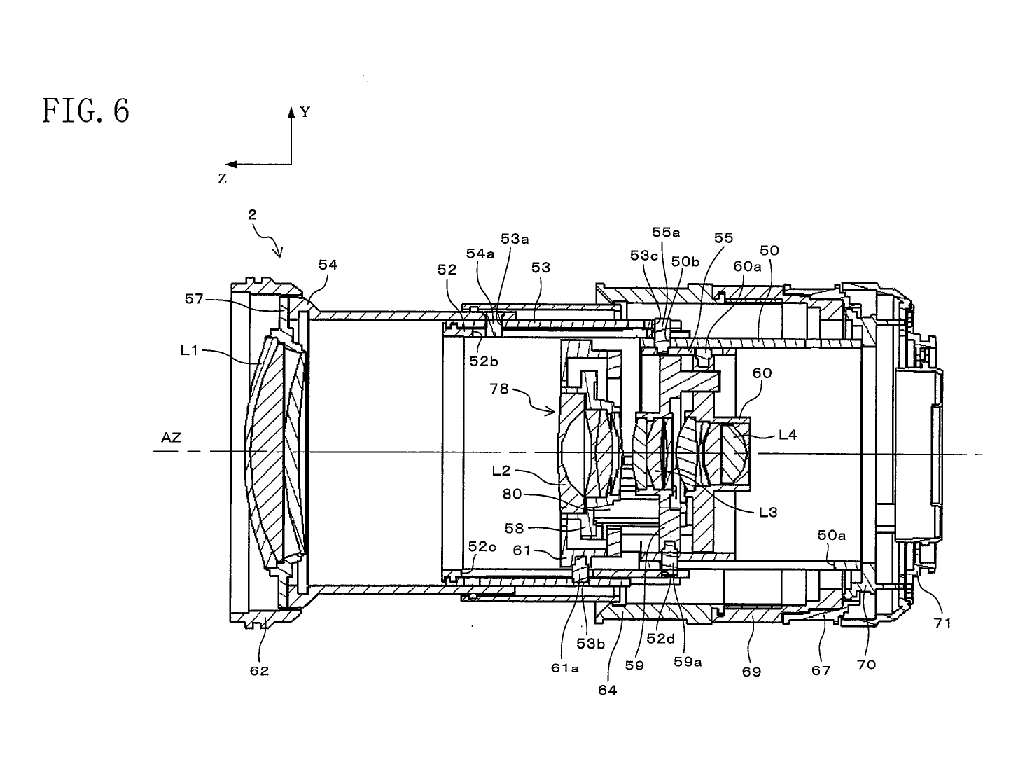

Thus, by rotating the zoom ring 64, the lens groups L1 through L4 of the interchangeable lens 2 move in the direction parallel to the optical axis AZ, from the state of a wide angle end shown in FIG. 5 to the state of a telescopic end shown in FIG. 6, whereby shooting can be performed at a predetermined zoom position.

At this time, the focus lens unit 78 mechanically moves in the direction parallel to the optical axis AZ, according to the movement of the first-second group rotary frame 53 and the first-second group linearly moving frame 52, by a rotating operation of the zoom ring 64. In this case, only the second group lens L2 is electrically drive-controlled in the focus lens unit 78 by the ultrasonic actuator unit 80, based on tracking information (a tracking table described below) pre-stored in the interchangeable lens 2, so as to attain an optimal in-focus state. For example, the second group lens L2 is driven by the ultrasonic actuator unit 80 to be in focus on infinity, based on the tracking information, and maintains the infinity in-focus state even if the second group lens L2 moves from the wide angle end to the telescopic end, or moves in the opposite direction, which is from the telescopic end to the wide angle end.

More specifically, when the zoom ring 64 is rotated, the first group lens L 1, the second group lens L2, the third group lens L3, and the fourth group lens L4 move along the optical axis AZ. Thus, the imaging optical system L changes the magnification of an object image. At this time, as a matter of course, the second group lens L2 also moves along the optical axis AZ, while being supported by the second group holder 61 with the second group lens holding frame 58 interposed therebetween. When the relative positional relation among the first group lens L1, the second group lens L2, the third group lens L3, and the fourth group lens L4 changes, the focus state of the object image that is formed on the image sensor 11 also changes. That is, the object point distance of the object that is focused on the image sensor 11 (hereinafter also referred to as the “object distance”) changes.

Thus, by driving the ultrasonic actuator unit 80, the second group lens holding frame 58 for holding the second group lens L2 is moved relative to the second group holder 61 that is moved by a cam mechanism. That is, the second group lens L2 is moved independently of the cam mechanism for driving the second group holder 61. More specifically, the second group lens L2 is moved along the optical axis AZ so that the object distance becomes substantially constant according to the magnification changing operation. Note that the expression “the object distance is substantially constant” means that the object distance falls within a predetermined depth of field.

A position in the optical axis AZ direction of the second group lens L2, where the object distance becomes substantially constant even with the magnification changing operation, is herein referred to as a tracking table. In other words, the “tracking table” is a relation between the focal length that is determined for every object distance, and the position in the optical axis AZ direction of the second group lens L2. Note that the “focal length” can be paraphrased as the “rotation position of the zoom ring 64,” as the “position in the optical axis AZ direction of the first group lens L1, the third group lens L3, or the fourth group lens L4,” or as the “detection result of the zoom ring angle detection section 65.” Moreover, the “position in the optical axis AZ direction of the second group lens L2” can be paraphrased as the “position of the second group lens L2 with respect to the second group holder 61,” or as the “position in the optical axis AZ direction of the second group lens L2 in the interchangeable lens 2.” The tracking tables used in the present embodiment can use any of the relations represented by the above paraphrases.

The tracking tables are stored in a memory in the interchangeable lens 2. More specifically, the relation between the rotation position information of the zoom ring 64, and the position information of the second group lens L2 in the interchangeable lens 2 in the optical axis AZ direction, is stored in the memory as table information for each object distance (e.g., 0.5 m, 1.0 m, 2.0 m, ∞, and the like).

First, the lens microcomputer 40 obtains information about the position of the second group lens L2 corresponding to an object distance, for example, position information of the second group lens L2 in the interchangeable lens 2 in the optical axis AZ direction, and also, obtains information about the position of the second group lens L2 corresponding to a focal length, for example, rotation position information of the zoom ring 64. Then, based on the obtained information about the position of the second group lens L2 corresponding to the object distance, the lens microcomputer 40 selects a tracking table corresponding to this object distance.

Then, the lens microcomputer 40 again obtains information about the position of the second group lens L2 corresponding to a focal length, for example, rotation position information of the zoom ring 64. Then, the lens microcomputer 40 obtains a changing speed of the focal length, that is, a rotating speed of the zoom ring 64.

Then, the lens microcomputer 40 predicts the rotation position of the zoom ring 64 after a predetermined time, based on a current rotation position of the zoom ring 64 and the rotating speed of the zoom ring 64, and obtains the position in the optical axis AZ direction of the second group lens L2 at the predicted rotation position of the zoom ring 64, based on the tracking table selected in advance.

Then, the lens microcomputer 40 sets the obtained optical axis AZ direction position as a target position, and drives the ultrasonic actuator unit 80 to move the second group lens L2 so that the second group lens L2 is positioned at the target position after the predetermined time.

Thus, in the electronic tracking operation, the lens microcomputer 40 predicts the focal length according to the magnification changing operation, and obtains a target position of the second group lens L2 corresponding to the predicted focal length, from the tracking table, and then, moves the second group lens L2 to the target position by the ultrasonic actuator unit 80, concurrently with the magnification changing operation of the imaging optical system L. This operation is performed at predetermined time intervals. Thus, even if the zoom ring 64 is rotated, and the focal length of the imaging optical system L changes as a result, the second group lens L2 moves to the optical axis AZ direction position corresponding to the focal length, based on the tracking table, whereby the object distance is held substantially constant. Note that this control may be performed by the body microcomputer 10, instead of the lens microcomputer 40.

Similarly, even if the second group lens L2 moves from the wide angle end to the telescopic end, or moves in the opposite direction, which is from the telescopic end to the wide angle end, in a short-distance in-focus state such as, e.g., 1 m, the short-distance in-focus state is maintained by driving the ultrasonic actuator unit 80, whereby smooth zoom operation can be implemented.

[Focusing Operation]

Next, focusing operation of the digital camera 1 will be described. The digital camera 1 has two focus modes: an auto-focusing shooting mode; and a manual-focusing shooting mode. The operator or the like, who operates the digital camera 1, sets a predetermined shooting mode by an auto-focusing shooting mode/manual-focusing shooting mode setting button, which is provided in the digital camera main body 3.

Auto-focusing operation using a contrast method is performed in the auto-focusing shooting mode.

When performing the contrast auto-focusing operation, the body microcomputer 10 requests contrast AF data from the lens microcomputer 40. The contrast AF data is data required to perform the contrast auto-focusing operation, and includes, e.g., a focus driving speed, a focus shift amount, image magnification, information on whether the contrast AF operation can be performed or not, and the like.

The body microcomputer 10 monitors if the shutter operation section 30 is half depressed or not. When the shutter operation section 30 is half depressed, the body microcomputer 10 sends an auto-focusing start command to the lens microcomputer 40. The auto-focusing start command is a command indicating that the contrast auto-focusing operation is to be started. In response to this command, the lens microcomputer 40 drive-controls the ultrasonic actuator unit 80, which is a focusing actuator. More specifically, the lens microcomputer 40 transmits a control signal to the focus lens drive control section 41, and drives the ultrasonic actuator unit 80 to slightly move the second group lens L2.

The body microcomputer 10 calculates an evaluation value for the auto-focusing operation (hereinafter referred to as the “AF evaluation value), based on received image data. More specifically, the body microcomputer 10 transmits a command to the digital signal processing section 15. The digital signal processing section 15 transmits an image signal to the body microcomputer 10 at a predetermined timing based on the received command. The body microcomputer 10 obtains a brightness signal from image data produced by the image sensor 11, and integrates high frequency components of the brightness signal in the screen to obtain an AF evaluation value (this method is known). This calculated AF evaluation value is stored in a DRAM (Dynamic Random Access Memory) (not shown), in association with an exposure synchronization signal. Moreover, lens position information obtained from the lens microcomputer 40 has also been associated with the exposure synchronization signal. Thus, the body microcomputer 10 can store the AF evaluation value in association with the lens position information.

Next, the body microcomputer 10 obtains a contrast peak based on the AF evaluation value stored in the DRAM, and monitors if an in-focus point has been able to be extracted or not. More specifically, the position of the second group lens L2, where the AF evaluation value becomes a maximal value, is extracted as the in-focus point. A mountain climbing method is commonly known as this lens driving method.

More specifically, the body microcomputer 10 drives the ultrasonic actuator unit 80 via the lens microcomputer 40 to move the focus lens group in such a direction that the AF evaluation value increases, thereby obtaining an AF evaluation value at each lens position. This operation is continued until the peak of the AF evaluation value is detected, that is, until the AF evaluation value starts decreasing after increasing and reaching the peak.

Then, the body microcomputer 10 transmits a control signal to the focus lens drive control section 41 via the lens microcomputer 40, so that the second group lens L2 is located at a position corresponding to the extracted in-focus point. The focus lens drive control section 41 produces a driving signal for driving the ultrasonic actuator unit 80, based on the control signal from the body microcomputer 10 (or the lens microcomputer 40). The ultrasonic actuator unit 80 is driven based on the driving signal. By driving the ultrasonic actuator unit 80, the second group lens L2 automatically moves to the position corresponding to the extracted in-focus point, in the direction parallel to the optical axis AZ.

The focusing operation in the auto-focusing shooting mode of the digital camera 1 is performed in this manner. The above operation is carried out instantaneously after the operator or the like half depresses the shutter operation section 30.

Moreover, in this state, the camera system 1 can operate in a control mode for displaying an image, indicated by image data produced by the image sensor 11, as a through image on the display section 20. This control mode is called a live view mode. In the live view mode, since the through image is displayed on the display section 20 as a moving picture, the user can determine the composition for imaging a still picture or a moving picture, while looking at the display section 20. A user-selectable control mode, other than the live view mode using the display section 20, is a second live view mode for guiding an object image, obtained from the interchangeable lens 2, to the liquid crystal viewfinder (the finder section 38).

Thus, the contrast method is suitable as an auto-focusing operation method in the live view mode (a through image mode) using the display section 20. This is because, in the live view mode, image data is steadily produced by the image sensor 11, and thus, it is easy to perform the contrast auto-focusing operation using the image data.

Then, the manual-focusing shooting mode is described.

When the focus ring 67 is rotated by the operator or the like, the focus ring angle detection section 68 detects a rotation angle, and outputs a signal according to the rotation angle. The focus lens drive control section 41 is capable of receiving a signal from the focus ring angle detection section 68, and is capable of transmitting a signal to the ultrasonic actuator unit 80. The focus lens drive control section 41 transmits the determined result to the lens microcomputer 40. The focus lens drive control section 41 drives the ultrasonic actuator unit 80 based on a control signal from the lens microcomputer 40. More specifically, the lens microcomputer 40 generates a drive signal for driving the ultrasonic actuator unit 80, based on the focus ring rotation angle signal. When the ultrasonic actuator unit 80 moves in the direction parallel to the optical axis AZ by the drive signal, the second group lens holding frame 58, fixed to the ultrasonic actuator unit 80, also moves in the direction parallel to the optical axis AZ. In the state of the wide angle end shown in FIG. 5, the second group lens L2 is located at an infinity position as a distance to the object. As the distance to the object becomes shorter, the second group lens L2 moves in the positive direction of the Z axis. Similarly, in the state of the telescopic end shown in FIG. 6, the second group lens L2 is located at an infinity position as a distance to the object. As the distance to the object becomes shorter, the second group lens L2 moves in the positive direction of the Z axis, where the moving amount of the second group lens L2 is larger than that in the case of the wide angle end.

The focusing operation in the manual-focusing shooting mode of the digital camera 1 is performed in this manner. The operator or the like can perform the focusing operation by rotating the focus ring 67 while confirming the object on the display section 20. If the operator or the like performs fully depresses the shutter operation section 30 in the manual-focusing mode, shooting is performed in this state.

[Shooting Operation]

When the operator fully depresses the shutter operation section 30, the body microcomputer 10 transmits a command to the lens microcomputer 40 so as to attain an aperture value calculated based on an output from a photometric sensor (not shown). Then, the lens microcomputer 40 controls the aperture drive control section 42 to stop down the aperture to the aperture value as instructed. Simultaneously with the instruction regarding the aperture value, a command to drive the image sensor 11 is output from the image sensor drive control section 12, giving instructions regarding operation of the shutter unit 33. The image sensor drive control section 12 exposes the image sensor 11 only for a time period of the shutter speed calculated based on the output from the photometric sensor (not shown).

After shooting processing is performed, and shooting is finished, the body microcomputer 10 transmits a control signal to the image recording control section 19. The image reading/recording section 18 records an image signal in the internal memory and/or the removable memory, based on a command of the image recording control section 19. The image reading/recording potion 18 records shooting mode information (the auto-focusing shooting mode or the manual-focusing shooting mode) with the image signal in the internal memory and/or the removable memory, based on a command of the image recording control section 19.

Moreover, after the exposure is completed, the image sensor drive control section 12 reads image data from the image sensor 11, and performs predetermined image processing, and then the image data is output to the image display control section 21 via the body microcomputer 10. Thus, the captured image is displayed on the display section 20.

Moreover, after the exposure is completed, the body microcomputer 10 resets the shutter unit 33 to an initial position. Moreover, the body microcomputer 10 sends a command to the lens microcomputer 40 to instruct the aperture drive control section 42 to reset the aperture to an open position, and the lens microcomputer 40 sends the reset command to each unit. After the resetting is completed, the lens microcomputer 40 notifies the body microcomputer 10 of the completion of the resetting. The body microcomputer 10 waits for the reset completion information from the lens microcomputer 40, and waits for a series of processing after the exposure to be completed, and then, confirms that the shutter operation section 30 is not in a depressed state, thereby completing the shooting sequence.

(2.3: Operation When Capturing a Moving Picture)

The camera system 1 further has a function to capture a moving picture. When capturing a moving picture, image data is steadily produced in the image sensor 11. The body microcomputer 10 has a control mode for controlling the second group lens L2 based on the image data to continuously perform the auto-focusing operation when capturing a moving picture (hereinafter also referred to as the “constant AF mode”). More specifically, the body microcomputer 10 executes the constant AF mode by controlling the lens microcomputer 40. The expression “capture a moving picture” is a concept including moving-picture recording shooting operation for capturing a moving picture while recording in the image reading/recording section 18 by the image recording control section 19, and the live view mode, described above, for capturing a moving picture without recording in the image reading/recording section 18 by the image recording control section 19.

[Constant AF Mode]

Next, operation in the constant AF mode will be described.

First, the lens microcomputer 40 selects a tracking table corresponding to the object distance, and obtains a current focal length and the changing speed of the focal length (that is, the rotation position and the rotating speed of the zoom ring 64), according to procedures similar to those performed when starting the electronic tracking described above.

Then, the lens microcomputer 40 performs wobbling (fine reciprocal vibration).

More specifically, the lens microcomputer 40 obtains a focal length after a predetermined first time, a focal length after a predetermined second time, and a focal length after a predetermined third time from the current time, based on the current focal length and the changing speed of the focal length. Then, the lens microcomputer 40 refers to the selected tracking table to obtain positions in the optical axis AZ direction of the second group lens L2, respectively corresponding to the focal length after the first time and after the second time. The lens microcomputer 40 then sets, as a first target position, a position in the optical axis AZ direction where the object distance becomes longer by a predetermined amount than that at the position in the optical axis AZ direction of the second group lens L2 obtained based on the tracking table corresponding to the focal length after the first time. Moreover, the lens microcomputer 40 sets, as a second target position, a position in the optical axis AZ direction where the object distance becomes shorter by a predetermined amount than that at the position in the optical axis AZ direction of the second group lens L2 obtained based on the tracking table corresponding to the focal length after the second time.

Then, the lens microcomputer 40 drives the ultrasonic actuator 80 so that the second group lens L2 is located at the first target position after the first time, and is located at the second target position after the second time. At this time, the body microcomputer 10 calculates an AF evaluation value based on image data, which is output from the image sensor 11 during a period including the time the second group lens L2 is located at the first target position. This AF evaluation value is set as a first AF evaluation value. Moreover, the body microcomputer 10 calculates an AF evaluation value based on image data, which is output from the image sensor 11 during a period including the time the second group lens L2 is located at the second target position. This AF evaluation value is set as a second AF evaluation value.

Then, the body microcomputer 10 compares the first AF evaluation value with the second AF evaluation value. As a result, if the first AF evaluation value is larger than the second AF evaluation value, the body microcomputer 10 reselects a tracking table corresponding to an object distance longer than that corresponding to the currently set tracking table. On the other hand, if the second AF evaluation value is larger than the first AF evaluation value, the body microcomputer 10 reselects a tracking table corresponding to an object distance shorter than that corresponding to the currently set tracking table.

Then, the lens microcomputer 40 obtains a position in the optical axis AZ direction of the second group lens L2, corresponding to the focal length after the third time, based on the reselected tracking table, and sets the obtained position in the optical axis AZ direction as a third target position, and then, drives the ultrasonic actuator unit 80 so that the second group lens L2 is located at the third target position after the third time.

Note that, if the zoom ring 64 is not rotated, the respective focal lengths after the first time, the second time, and the third time are the same, and the first target position and the second target position are respectively located in front of, and behind the current position of the second group lens L2 in the optical axis AZ direction.

This operation is repeated during the constant AF mode.

Thus, even if the focal length of the imaging optical system L changes by rotation of the zoom ring 64, the second group lens L2 moves to the position in the optical axis AZ direction according to the focal length, based on the tracking table, and the object distance is maintained substantially constant. In addition, even if a tracking table is not selected appropriately, or if the tracking table becomes no longer appropriate as the distance in the optical axis AZ direction between the object and the camera system 1 changes, an appropriate tracking table is reselected based on the AF evaluation value of the image, whereby an excellent in-focus state can be maintained.

However, there is an upper limit of the moving speed of the second group lens L2. Thus, when the operator rotates the zoom ring 64 too fast that it is difficult to move the second group lens L2 to the position in the optical axis AZ direction corresponding to a predicted focal length after a predetermined time, the lens microcomputer 40 performs control similar to that in the electronic tracking described above, without performing wobbling.

The constant AF mode enables a moving picture to be recorded while maintaining a desirable in-focus state, when performing the moving-picture recording shooting operation. Moreover, the constant AF mode enables the live view mode maintaining a desirable in-focus state to be implemented. Maintaining a desirable in-focus state in the live view mode can provide the effect of enabling a release time lag to be reduced, and the effect of enabling the control mode to be switched among various control modes according to the object distance.

### Effects of the Present Embodiment

As described above, according to the present invention, by driving a focus lens group by using a linear actuator, inversion operation in the movement of the focus lens group can be performed more smoothly and at a higher speed, as compared to the case of driving the focus lens group by using a cam. Moreover, the mountain climbing auto-focusing operation described above can be performed smoothly at a high speed. Moreover, the wobbling described above can be performed smoothly at a high speed.

Moreover, the focus unit itself, including the linear actuator, is driven with zoom lens groups by a cam mechanism. Thus, even if the zoom operation section is operated by the user at a high speed, the focus lens group can be moved at a high speed by the cam mechanism. Thus, in the case where the object distance should be maintained substantially constant before and after the magnification changing operation, the linear actuator need only move a focus lens by the amount resulting from subtracting the amount by which the focus lens is moved by the cam mechanism, from the amount by which the focus lens should be moved. This facilitates adaptation to the high-speed operation of the zoom operation section by the user.

Note that it is preferable to reduce the looseness of the cam mechanism for driving the focus unit, since smooth and high-speed operation of the cam mechanism can be implemented. In this case, large power is required by operation of the cam mechanism. However, such large power can be provided by, for example, performing the magnification changing operation of the focus lens only by operation of the user, that is, by performing no magnification changing operation electrically. This is because the power obtained by operation of the user is generally larger than that obtained by an electric power generation source. Moreover, as the looseness is reduced, a power generation source for generating larger power, for example, can be used as a power generation source for operation of the cam mechanism. In this case, since larger power is generated, the power generation source is increased in size, and the power consumption is increased, whereby it is preferable to perform the magnification changing operation only manually as described above.

Moreover, the use of an ultrasonic actuator as a linear actuator can prevent generation of gear noise during driving, which occurs in a DC (direct-current) motor using a gear train, and the like. Thus, recording of driving noise, generated during focusing operation, can be prevented. That is, the focus lens group can be driven with high resolution, high performance, and low noise. As a result, not only still picture shooting, but also moving picture shooting that cannot be implemented by conventional single-lens reflex cameras, can be implemented.

Moreover, an effective lens diameter generally increases as the lens is located closer to the object. Thus, the lens diameter increases as the lens is located closer to the object side. Since the focus lens group of the present embodiment is the second lens group from the object side, this focus lens group has a large lens diameter, and is heavy. Thus, in the case of moving the focus lens group only by a linear actuator, it is necessary to move the heavy focus lens group at a high speed according to the high-speed operation of the zoom operation section by the user. This requires a larger linear actuator to be provided. In the present embodiment, however, as described above, the focus lens group is moved in the optical axis AZ direction by the cam mechanism according to the magnification changing operation, even if the zoom operation section is operated at a high speed by the user. Thus, the linear actuator need only move the focus lens group only by the amount resulting from subtracting the amount by which the focus lens group is moved by the cam mechanism, from the amount by which the focus lens group should be moved. That is, in the focusing operation during the magnification changing operation, the focus lens group is moved by the cam mechanism by a part of the moving distance of the focus lens group required to bring an object image into focus, and is moved by the linear actuator by the remaining part of the moving distance. This configuration can reduce the moving amount of the focus lens group by the linear actuator, and as a result, can prevent an increase in size of the linear actuator. In another possible configuration, in the focusing operation during the magnification changing operation, the focus lens group is first roughly moved by the cam mechanism by the distance required to bring an object image into focus, and then, the position of the focus lens group is adjusted by the linear actuator so as to bring the object image into focus. Thus, according to the present embodiment, the focus lens group can be provided at the second position from the object side without increasing the size of the linear actuator, whereby the degree of freedom in lens design can be increased.

Moreover, since contrast detection AF operation is performed by the imaging device provided in the camera main body, a conventional phase difference detection method using a reflection mirror is not used. Thus, a system eliminating a reflection mirror unit can be configured, whereby reduction in size of the camera main body can be achieved.

Moreover, eliminating the reflection mirror unit can reduce the lens back, whereby reduction in size of the interchangeable lens can be achieved.

That is, since a common type of single-lens reflex cameras uses a reflection mirror inside, the reflection mirror needs to be positioned in front of the image sensor, making it difficult to reduce the thickness of the camera main body. Another disadvantage is that, since a long lens back is required, the size becomes larger as compared to range finder type optical systems. The present embodiment can eliminate these disadvantages.

Moreover, since the focus lens group is linearly driven in the direction parallel to the optical axis by the ultrasonic actuator, the focus lens group can be driven with high resolution, high performance, and low noise, in addition to a high-speed response property. Thus, not only still-picture shooting, but also moving-picture shooting that cannot be implemented by conventional single reflex cameras, can be implemented. Moreover, unlike common electromagnetic linear actuators, the use of the ultrasonic actuator enables the lens group to be self-held when being de-energized. This can reduce the electric power, or can eliminate generation of impact noise, which is generated when the second group lens L2 moves unexpectedly and strikes other parts.

### Other Embodiments

The present embodiment has been described with respect to the ultrasonic actuator unit having a self-propelled configuration in which the driver elements form a movable portion. However, the ultrasonic actuator unit may have a reverse configuration in which the driver elements form a fixed portion. Moreover, the configuration of the ultrasonic actuator unit is not limited to the type using stretching vibration and bending vibration, but other types of the configuration may be used.

Moreover, in the present embodiment, the second group lens L2 is used as the focus lens group. However, the present invention is not limited to this, and other lens group, such as the third lens group L3 or the fourth group lens L4, may be used as the focus lens group. Moreover, the present embodiment has been described with respect to the case where one second group lens L2 is used as the focus lens group. However, the present invention is applicable also to an optical system for performing focusing operation by cooperatively operating a plurality of lens groups. Moreover, the present invention may be configured so that the second group lens L2 is divided into two, where one is held by the second group lens holding frame 58, and the other is held by the second group holder 61.

Moreover, the present embodiment may be a camera system in which an image blur correction unit is provided in one or both of the interchangeable lens and the camera main body, and one of the image blur correction units can be selected.

Moreover, the interchangeable lens of the present embodiment can be attached to a conventional type single-lens reflex camera main body including a reflecting mirror unit. In this case, a reflecting mirror is withdrawn from an optical path, and contrast detection is performed by an image sensor, whereby the interchangeable lens can be used in substantially the same manner. Moreover, when a focus driving interchangeable lens using this ultrasonic actuator unit is attached, the system may be such that information that the interchangeable lens has been attached is detected by a camera main body, and the focus detection method of the camera main body can be automatically changed from a conventional phase difference detection method to a contrast detection method.

Moreover, the present embodiment has been described with respect to a zoom lens. However, the present invention may be a single focal length interchangeable lens.

Moreover, the present embodiment has been described only with respect to the case where the present invention is applied to a single-lens reflex system capable of exchanging a lens. However, the present invention is applicable also to a system in which a camera main body and a lens barrel are formed integrally, where contrast detection can be preformed.

Moreover, in the present embodiment, the focal length is changed by manually operating the zoom ring. However, the present invention is not limited to this, and may include an electric zoom method.

Moreover, in the present embodiment, the shutter is operated to control the exposure time of the image sensor. However, the present invention is not limited to this, and the exposure time of the image sensor may be controlled by an electric shutter or the like.

Moreover, in other words, an interchangeable lens according to the present embodiment includes: a focus lens group for being advanced and withdrawn in an optical axis direction to change a focus state of an object image, whereby an auto-focusing evaluation value is calculated based on image data produced by an imaging device provided in a camera body; an ultrasonic actuator for driving the focus lens group; a focus unit for supporting the focus lens group so that the focus lens group is slidable in a direction parallel to an optical axis, where the focus unit is capable of moving the focus lens group and the ultrasonic actuator in the direction parallel to the optical axis by zoom operation; and a focus drive control section for drive-controlling the ultrasonic actuator based on the auto-focusing evaluation value.

Moreover, in other words, a camera system according to the present embodiment is a camera system for capturing an object, and includes: an imaging device for imaging the object; a body control section for controlling the camera body; a focus lens group for being advanced and withdrawn in an optical axis direction to change a focus state of the object image; an evaluation value calculating section for calculating an auto-focusing evaluation value, based on image data produced by the imaging device by driving of the focus lens group; an ultrasonic actuator for driving the focus lens group; a focus unit for supporting the focus lens group so that the focus lens group is slidable in a direction parallel to an optical axis, where the focus unit is capable of moving the focus lens group and the ultrasonic actuator in the direction parallel to the optical axis by zoom operation; and a focus drive control section for drive-controlling the ultrasonic actuator. The body control section controls auto-focusing operation of the camera system, based on the evaluation value calculated by the evaluation value calculating section.

Note that the above embodiments are essentially preferred examples, and are not intended to limit the invention, its applications, and the range of its uses.

### INDUSTRIAL APPLICABILITY

An interchangeable lens and a camera system using the same according to the present invention are preferable for digital still cameras, digital video cameras, mobile phones having a camera section, PDAs (Personal Digital Assistances), and the like, for which a high quality image is required.

1. An interchangeable lens, comprising:
an imaging optical system including a focus lens group for changing a focus state of an object image, and a zoom lens group for changing magnification of the object image;
a zoom operation section that is operated by a user;
a cam mechanism for mechanically transmitting operation of the zoom operation section to the zoom lens group to move the zoom lens group in a direction parallel to an optical axis; and
a focus unit for advancing and withdrawing the focus lens group in an optical axis direction, where the focus unit itself is also moved in the direction parallel to the optical axis by the cam mechanism, wherein
the focus unit supports the focus lens group so that the focus lens group is movable in the optical axis direction, and has a linear actuator for moving the focus lens group in the optical axis direction.

2. The interchangeable lens of claim 1, wherein
the linear actuator is an ultrasonic actuator.

3. The interchangeable lens of claim 2, wherein
the focus unit has a fixed body, and a movable body including at least the focus lens group, and being configured so as to be movable with respect to the fixed body, and
the ultrasonic actuator is disposed so as to be fixed to one of the fixed body and the movable body, and to be in sliding contact with the other of the fixed body and the movable body, is configured so as to move the movable body with respect to the fixed body by a frictional force, and is in sliding contact with the other of the fixed body and the movable body even when the ultrasonic actuator does not move the movable body.

4. The interchangeable lens of any one of claims 1 to 3, further comprising:
at least three lens groups, wherein
the focus lens group is a second lens group from an object side.

5. A camera system including a camera main body, and an interchangeable lens that is detachable from the camera main body, for capturing an object, comprising:
an imaging device provided in the camera main body, for imaging the object;
an imaging optical system provided in the interchangeable lens, and including a focus lens group for changing a focus state of an object image onto the imaging device, and a zoom lens group for changing magnification of the object image;
a zoom operation section provided in the interchangeable lens so as to be operated by a user;
a cam mechanism provided in the interchangeable lens, for mechanically transmitting operation of the zoom operation section to the zoom lens group to move the zoom lens group in a direction parallel to an optical axis;
a focus unit provided in the interchangeable lens, for advancing and withdrawing the focus lens group in an optical axis direction, where the focus unit itself is also moved in the direction parallel to the optical axis by the cam mechanism; and
a control section provided in the camera main body, for controlling the focus unit, wherein
the focus unit supports the focus lens group so that the focus lens group is slidable in the optical axis direction, and has a linear actuator for moving the focus lens group in the direction parallel to the optical axis, and
the control section controls the linear actuator to perform auto-focusing operation by a contrast detection method, based on an output of the imaging device.

6. The camera system of claim 5, wherein
the linear actuator is an ultrasonic actuator.

7. The camera system of claim 6, wherein
the focus unit has a fixed body, and a movable body including at least the focus lens group, and being configured so as to be movable with respect to the fixed body, and
the ultrasonic actuator is disposed so as to be fixed to one of the fixed body and the movable body, and to be in sliding contact with the other of the fixed body and the movable body, is configured so as to move the movable body with respect to the fixed body by a frictional force, and is in sliding contact with the other of the fixed body and the movable body even when the ultrasonic actuator does not move the movable body.

8. The camera system of any one of claims 5 to 7, further comprising:
at least three lens groups, wherein
the focus lens group is a second lens group from an object side.
